(19) United States
(12) Patent Application Publication
(10) Pub. No.: US 2026/0326071 A1
(43) Pub. Date: Oct. 22, 2026

(54) REAGENT DELIVERY SYSTEM WITH FLUIDIC DEVICE AND SENSOR

(71) Applicant: CUSTOMARRAY INC., Redmond, WA (US)

(72) Inventors: Cheng-Hsien WU, Redmond, WA (US); Hisashi FUJI, Redmond, WA (US); Jianzhu YIN, Redmond, WA (US)

(21) Appl. No.: 19/113,871

(22) PCT Filed: Sep. 22, 2023
(86) PCT No.: PCT/US2023/033443

§ 371 Date: Mar. 20, 2025

Related U.S. Application Data
(60) Provisional application No. 63/409,251, filed on Sep. 23, 2022.

(51) Int. Cl. B01J 19/00; B01L 3/00

(52) U.S. Cl. CPC B01J 19/0093; B01J 19/0053; B01L 3/502738; B01J 2219/00164; B01L 2200/0605

(57) ABSTRACT

Systems and devices for reagent delivery are described. In one example, a disclosed fluidic device comprises: a plurality of first inlet ports; a first common channel; a plurality of first valves each associated with one first inlet port; a plurality of second inlet ports; a second common channel; a plurality of second valves each associated with one second inlet port; a plurality of outlet ports; a third common channel; a plurality of third valves each associated with one outlet ports; a first shutoff valve fluidically coupled between the first and the third common channels; and a second shutoff valve fluidically coupled between the second and the third common channels. Each first or second valve is fluidically coupled between a first or second inlet port and the first or second common channel. Each third valve is fluidically coupled between an outlet port and the third common channel.

### PRIORITY CLAIM AND CROSS-REFERENCE

This application is a National Stage Application, filed under 35 U.S.C. 371, of International Patent Application No. PCT/US2023/033443, filed on Sep. 22, 2023, which claims the benefit of U.S. Provisional Application No. 63/409,251, filed Sep. 23, 2022, each of which is hereby incorporated by reference in its entirety for all purposes as if fully set forth herein.

### TECHNICAL FIELD

The disclosure relates generally to fluidic reagent delivery and, more particularly, to systems, devices and methods for delivering fluidic reagents with sensors for filling control.

### BACKGROUND

Microfluidics is considered a group of technology enabling small amount fluidic manipulation in chemical biology, chemical synthesis and lab-on-a-chip devices. The challenge of getting small amount of fluid from point A to point B lies in minimizing swept volume and dead volume, which would reduce reagent usage and cross-contamination. There has been a lot of interest in moving fluid in cross sectional area that is approximately 10-1000 μm² and in volume that is approximately 1-1000 μL. But distribution manifold technology is scarce in a slightly larger scope which is 0.1-10 mm² in cross sectional area and 1-100 mL in reagent volume.

Mechanical motion is used in some larger scale delivery applications. Mechanical pipets are easy to implement, yet suffers from low speed, atmosphere contamination and large volume needed in the fluidic connections. Smaller scale microfluidic devices were developed to spray/inkjet printing small droplet onto a substrate surface. This approach can achieve high resolution and small reaction droplet, yet is unsuitable for an enclosed reaction chamber. Microfluidic valve/manifold systems having zero dead volume have been developed at a smaller scale. The valve and the manifold have to be tightly integrated and therefore lack application flexibility and room of expansion.

Syringe pumps are traditionally the primary instrument to deliver small amount of liquid to desired location. But they are limited in volume capacity, chemical compatibility, pressure fluctuations and vibrations. Effort to expand their capability involves aspirating the medium from the outlet, sealing reservoir with permeable membrane and optimizing operating conditions. Pressure driven flow is an alternative which limits the dynamic forces, is pulseless, and has faster response time. The down side is that additional components are required to regulate dispensed volume.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In one embodiment, a fluidic device is disclosed. The fluidic device comprises: a plurality of first inlet ports; a first common channel; a plurality of first valves each associated with one of the plurality of first inlet ports; a plurality of second inlet ports; a second common channel; a plurality of second valves each associated with one of the plurality of second inlet ports; a plurality of outlet ports; a third common channel; a plurality of third valves each associated with one of the plurality of outlet ports; a first shutoff valve fluidically coupled between the first common channel and the third common channel; and a second shutoff valve fluidically coupled between the second common channel and the third common channel. Each first valve is fluidically coupled between an associated first inlet port and the first common channel. Each second valve is fluidically coupled between an associated second inlet port and the second common channel. Each third valve is fluidically coupled between an associated outlet port and the third common channel.

In another embodiment, a reagent delivery system is disclosed. The reagent delivery system comprises: a plurality of first reagent containers each containing a respective first liquid reagent that is selected from a first group; a plurality of second reagent containers each containing a respective second liquid reagent that is selected from a second group; a fluidic device that comprises a plurality of first inlet ports, a plurality of second inlet ports, and a plurality of outlet ports; and a plurality of chambers each comprising a first chamber port and a second chamber port. Each of the plurality of first reagent containers is fluidically coupled to one of the plurality of first inlet ports. Each of the plurality of second reagent containers is fluidically coupled to one of the plurality of second inlet ports. The first chamber port of each chamber is fluidically coupled to one of the plurality of outlet ports.

In yet another embodiment, a non-transitory computer-readable medium having stored thereon computer-executable instructions for carrying out a disclosed method performed by a disclosed device or system in some embodiment is disclosed.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1A illustrates an exemplary perspective view of an exemplary fluidic manipulation device, in accordance with some embodiments of the present disclosure.

FIG. 1B illustrates another exemplary perspective view of the fluidic manipulation device of FIG. 1A, in accordance with some embodiments of the present disclosure.

FIG. 2A illustrates an exemplary cross-sectional bottom view of the fluidic manipulation device of FIG. 1A, in accordance with some embodiments of the present disclosure.

FIG. 2B illustrates an exemplary cross-sectional side view of the fluidic manipulation device of FIG. 1A, in accordance with some embodiments of the present disclosure.

FIG. 2C illustrates another exemplary cross-sectional side view of the fluidic manipulation device of FIG. 1A, in accordance with some embodiments of the present disclosure.

FIG. 3A illustrates an exemplary perspective view of an exemplary valve in a fluidic manipulation device, in accordance with some embodiments of the present disclosure.

FIG. 3B illustrates an exemplary side and cross-sectional view of the valve in a fluidic manipulation device as shown in FIG. 3A, in accordance with some embodiments of the present disclosure.

FIG. 4 illustrates a barebone diagram of an exemplary fluidic manipulation device, in accordance with some embodiments of the present disclosure.

FIG. 5 illustrates an exemplary diagram of an exemplary reagent delivery system, in accordance with some embodiments of the present disclosure.

FIG. 6A illustrates an actuated fluidic pathway during a first operation of a washing liquid in the reagent delivery system of FIG. 5, in accordance with some embodiments of the present disclosure.

FIG. 6B illustrates an actuated fluidic pathway during a second operation of a washing liquid in the reagent delivery system of FIG. 5, in accordance with some embodiments of the present disclosure.

FIG. 7 illustrates an actuated fluidic pathway during a flush operation of a washing liquid in the reagent delivery system of FIG. 5, in accordance with some embodiments of the present disclosure.

FIG. 8 illustrates an actuated fluidic pathway during a purge operation of an inert gas in the reagent delivery system of FIG. 5, in accordance with some embodiments of the present disclosure.

FIG. 9A illustrates an actuated fluidic pathway during a prime operation of a dry reagent in the reagent delivery system of FIG. 5, in accordance with some embodiments of the present disclosure.

FIG. 9B illustrates an actuated fluidic pathway during a filling operation of a dry reagent into a chamber in the reagent delivery system of FIG. 5, in accordance with some embodiments of the present disclosure.

FIG. 9C illustrates an actuated fluidic pathway during a purge operation of a chamber filled with a dry reagent in the reagent delivery system of FIG. 5, in accordance with some embodiments of the present disclosure.

FIG. 10A illustrates an actuated fluidic pathway during a prime operation of a wet reagent in the reagent delivery system of FIG. 5, in accordance with some embodiments of the present disclosure.

FIG. 10B illustrates an actuated fluidic pathway during a filling operation of a wet reagent into a chamber in the reagent delivery system of FIG. 5, in accordance with some embodiments of the present disclosure.

FIG. 10C illustrates an actuated fluidic pathway during a purge operation of a chamber filled with a wet reagent in a reagent delivery system of FIG. 5, in accordance with some embodiments of the present disclosure.

FIGS. 11A-11B illustrate a fluidic manipulation device tested for manifold function in accordance with some embodiments. FIG. 11A is an exemplary cross-sectional side view of the fluidic manipulation device, and FIG. 11B is an exemplary cross-sectional bottom view of the fluidic manipulation device.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected,” “coupled,” and “interconnected,” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive. The term “substantially the same” will be understood to allow a variation such as ±10% or 5%.

The present disclosure provides a reagent distribution system that utilizes available valves and integrates them into a modular manifold. Actuation of corresponding valves would allow a selected reagent to flow from its corresponding inlet to a selected outlet. In some embodiments, the reagents that can flow through the reagent distribution system are segregated into two groups: a dry group and a wet group. A reagent in the dry group is substantially free of water or does not contain water, while a reagent in the wet group may contain water. A reagent in the dry group can be also referred as anhydrous, and may include a content of moisture less than 100 pm by weight. In some embodiments, the “dry” reagent includes a content of moisture less than 10 ppm. A reagent in the wet group may include water above 0.1% by weight of the reagent. In some embodiments, water is a solvent in a reagent in the wet group. In some embodiments, the reagents are used for synthesis of a biochemical such as DNA, RNA, and peptide, and the reaction is performed in a microfluidic device such as a microarray synthesis chip. For example, suitable examples of a reagent in the dry group may include, but are not limited to amidites, an activator and an inert gas. Suitable examples of a reagent in the wet group may include, but are not limited to oxidizer (OX), Cap A solution (Cap A), Cap B solution (Cap B), and an electro-chemical reaction medium (Echem). Cap A and Cap B are a first and a second capping reagents used for DNA synthesis. The segregation further reduces cross-contamination between the dry and wet reagent groups, and may be implemented by built-in shut-off valves that greatly reduce internal volume of the fluidic manifold.

In some embodiments, the fluidic system is sealed from atmosphere and free from such contamination, while driven by pressurized inert gas. A pressure driven reagent delivery system may utilize inert gas to prevent atmospheric contamination. The pressurized inert gas can push a desired reagent through the delivery manifold into a target chamber. The target chamber is filled up when its chamber outlet is brought to atmospheric pressure. The process is stopped when a bubble sensor positioned at the chamber outlet detects transition from gas to liquid. In some embodiments, the bubble sensor may be an ultrasonic bubble sensor that can monitor fluid flow in a non-invasive way. In certain non-continuous applications, a reagent delivery system is required to fill and drain a fixed-volume chamber. Therefore, the use of a bubble sensor on the chamber outlet would indicate if the liquid plug meniscus has gone past the chamber, indicating a full chamber when there is no additional bubble present.

In some embodiments, pressure sensors are positioned at the pressurized gas side to monitor the pressure, such that consistent and stable pressure difference can be achieved for flow and software control.

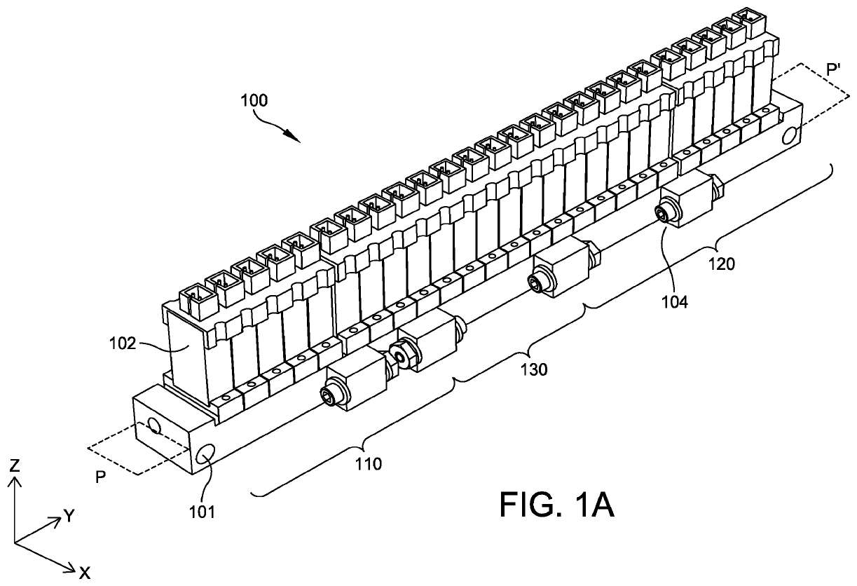

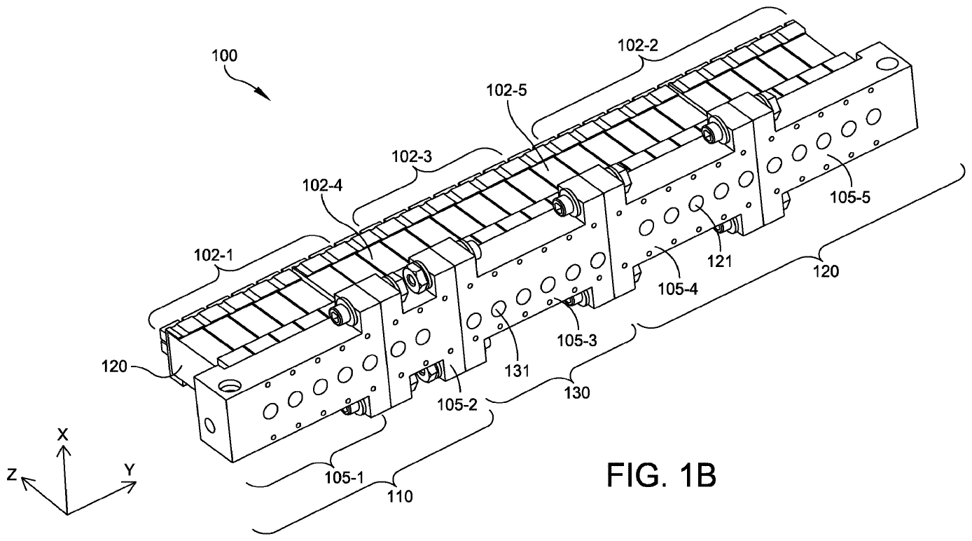

FIG. 1A illustrates an exemplary perspective view of a fluidic manipulation device 100, in accordance with some embodiments of the present disclosure. The fluidic manipulation device described herein is also referred as a fluidic device or a fluid delivery device, and is a fluidic device for delivering one or more different fluids or chemicals. The fluidic device is a microfluidic device in some embodiments. The term “manipulation” can be understood to encompass delivering different chemicals with precision control, for example, delivering dry and wet chemicals using the same device structures while keeping them separate without any contamination. Such a device may have suitable dimensions, for example, at millimeter or centimeter level. Such a device may be a stand-alone unitary device, or may have its components in one panel or block. The device may be used to move and deliver a fluid in a suitable cross sectional area, for example, in a range of from 0.1 square millimeters to 10 square millimeters in some embodiments. As shown in FIG. 1A, the exemplary fluidic manipulation device 100 includes a plastic base 101 and a plurality of valves 102. In this example, the plastic base 101 comprises five blocks that form three sections: a first input section 110, a second input section 120, and an output section 130. The five blocks 105-1, 105-2, 105-3, 105-4, 105-5 (FIG. 1B) are connected and integrated together along a straight line using fasteners 104 located on both sides of the fluidic manipulation device 100. The numbers of the valves and the ports described herein are for the purpose of illustration only, and may be any suitable numbers.

FIG. 1B illustrates another exemplary perspective view of the fluidic manipulation device 100, in accordance with some embodiments of the present disclosure. The perspective view in FIG. 1B shows the bottom of the fluidic manipulation device 100. As shown in FIG. 1B, there are many ports on the bottom of the fluidic manipulation device 100. In this example, the first input section 110 of the fluidic manipulation device 100 has a suitable first quantity such as seven first inlet ports 111, while the second input section 120 of the fluidic manipulation device 100 has a suitable second quantity such as ten second inlet ports 121. In addition, the output section 130 of the fluidic manipulation device 100 has six outlet ports 131. The valves 102 are integrated into different sections of the plastic base 101, and include: a plurality of first valves 102-1, a plurality of second valves 102-2, a plurality of third valves 102-3, a first shutoff valve 102-4, and a second shutoff valve 102-5.

As shown in FIG. 1B, the first input section 110 of the fluidic manipulation device 100 is formed by two integrated plastic blocks: one plastic block 105-1 having five inlet ports and another plastic block 105-2 having two inlet ports. The second input section 120 of the fluidic manipulation device 100 is formed by two integrated plastic blocks: one plastic block 105-4 having five inlet ports and another plastic block 105-5 also having five inlet ports. The output section 130 of the fluidic manipulation device 100 is formed by one single piece of plastic block 105-3 that includes six outlet ports.

As shown in FIG. 1A and FIG. 1B, each inlet and outlet port is associated with a corresponding valve 102 that is integrated to the plastic base 101 and disposed on top of the port. Each first valve 102-1 is associated with one of the first inlet ports 111 in the first input section 110; each second valve 102-2 is associated with one of the second inlet ports 121 in the second input section 120; and each third valve 102-3 is associated with one of the outlet ports 131 in the output section 130. The term “associated with” used herein will be also understood as “coupled with” or “corresponding with.” The term “coupled” refers to directly or indirectly connected with each other. In this example, there are 23 ports in total, while there are 25 valves in total. This is because there are two special valves: the first shutoff valve 102-4 that is disposed in the first input section 110 and closer (or adjacent) to the output section 130 than all other valves in the first input section 110; and the second shutoff valve 102-5 that is disposed in the second input section 120 and closer (adjacent) to the output section 130 than all other valves in the second input section 120. For each of the two shutoff valves 102-4, 102-5, there is no associated port on the bottom of the first input section 110.

In some embodiments, the 25 valves 102 in the fluidic manipulation device 100 are arranged in a row, with every two adjacent valves disposed close to each other with negligible space therebetween. Along the Y direction, a distance between every two adjacent first inlet ports 111 is a first distance; a distance between every two adjacent second inlet ports 121 is a second distance; and a distance between every two adjacent outlet ports 131 is a third distance. In some embodiments, all of the first distance, the second distance, and the third distance are the same as each other, and substantially the same as a width of each valve 102 along the Y direction. This compact design of the fluidic manipulation device 100 can reduce the internal volume of the fluidic manipulation device 100. As shown in FIGS. 1A-1B, the X direction and the Y direction is along the width direction and the longitudinal direction of the device, respectively, and the Z direction is along the height direction of the device. The three directions are normal to one another.

In some embodiments, the fluidic manipulation device 100 has a length of about 20 cm along the Y direction, a width of about 2~3 cm along the X direction, and a height of about 5 cm along the Z direction.

As shown in FIG. 1A and FIG. 1B, all valves including the first valves 102-1, the second valves 102-2, the third valves 102-3, the first shutoff valve 102-4, and the second shutoff valve 102-5, are disposed in parallel and on a same first side (i.e. the top side) of the fluidic manipulation device 100. All ports including the first inlet ports 111, the second inlet ports 121, and the outlet ports 131 are disposed on a same second side (i.e. the bottom side) of the fluidic manipulation device 100. In some embodiments, the outlet ports 131 may be on an opposite side of a side where the first inlet ports 111 and the second inlet ports 121 are located. Accordingly, the third valves 102-3 may be on an opposite side of a side where the other valves are located.

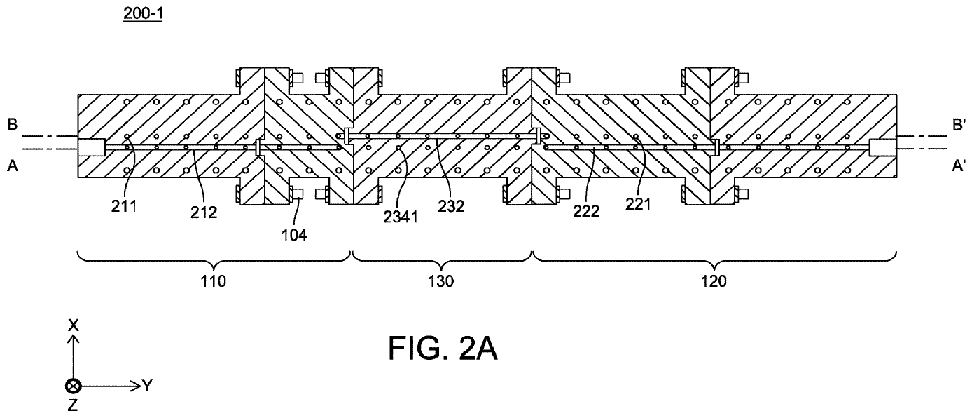

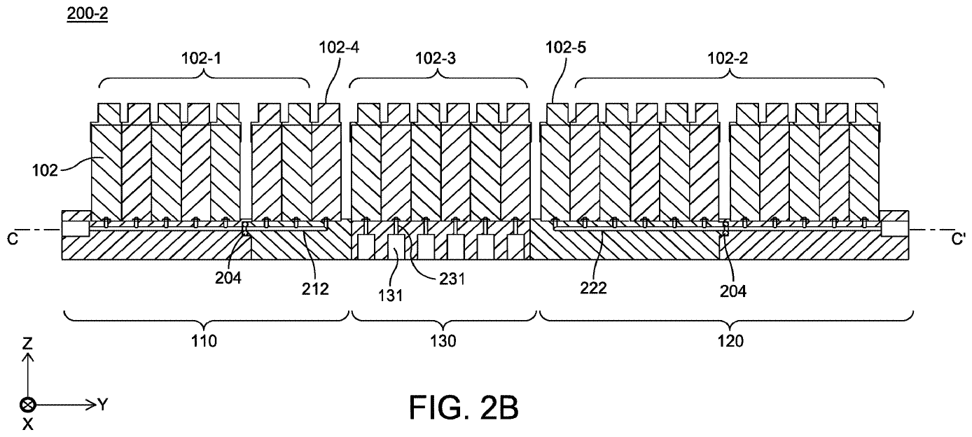

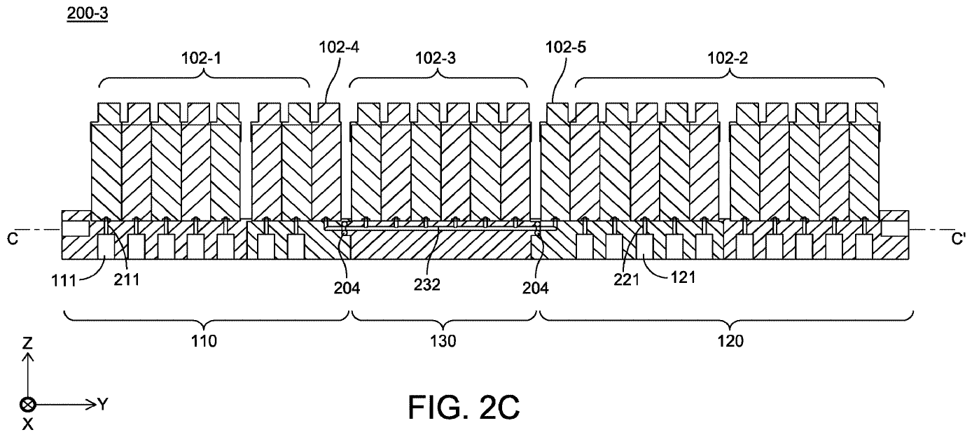

As shown in FIG. 1B, the first inlet ports 111 in the first input section 110 and the second inlet ports 121 in the second input section 120 are all aligned up and arranged along one straight line in the Y direction. In addition, the outlet ports 131 in the output section 130 are all aligned up and arranged along another straight line in the Y direction. This will be better shown in FIG. 2A.

FIG. 2A illustrates an exemplary cross-sectional bottom view 200-1 of a fluidic manipulation device, e.g. the fluidic manipulation device 100 in FIG. 1A and FIG. 1B, in accordance with some embodiments of the present disclosure. In some embodiments, the cross-sectional bottom view 200-1 can be obtained by cutting the fluidic manipulation device 100 in FIG. 1A along the plane P-P′, and looking from the bottom up along the Z direction. FIG. 2B illustrates an exemplary cross-sectional side view 200-2 of a fluidic manipulation device, e.g. the fluidic manipulation device 100 in FIG. 1A and FIG. 1B, in accordance with some embodiments of the present disclosure. In some embodiments, the cross-sectional side view 200-2 can be obtained by cutting the fluidic manipulation device 100 along the line A-A′ shown in FIG. 2A, and looking from the side of the fluidic manipulation device 100 along the −X direction (i.e. looking down in FIG. 2A), without cutting the bottom of the fluidic manipulation device 100. FIG. 2C illustrates another exemplary cross-sectional side view 200-3 of a fluidic manipulation device, e.g. the fluidic manipulation device 100 in FIG. 1A and FIG. 1B, in accordance with some embodiments of the present disclosure. In some embodiments, the cross-sectional side view 200-3 can be obtained by cutting the fluidic manipulation device 100 along the line B-B′ shown in FIG. 2A, and looking from the side of the fluidic manipulation device 100 along the −X direction (i.e. looking down in FIG. 2A), without cutting the bottom of the fluidic manipulation device 100. In some embodiments, the cross-sectional bottom view 200-1 can also be obtained by cutting the fluidic manipulation device 100 along the line C-C′ in FIG. 2B or FIG. 2C, and looking from the bottom up along the Z direction, without cutting the side of the fluidic manipulation device 100.

As shown in FIG. 2A, the first input section 110 may include a first common channel 212, which extends horizontally along the Y direction; and the second input section 120 may include a second common channel 222, which extends horizontally along the Y direction. Further, the output section 130 may also include a third common channel 232, which extends horizontally along the Y direction. The term “a common channel” used herein are understood to encompass a channel belonging to or shared by two or more ports or valves.

As shown in FIG. 2A and FIG. 2C, the first input section 110 includes a plurality of first inlet channels 211 each corresponding to and connecting to one of the first inlet ports 111. Each first inlet channel 211 extends vertically along the Z direction in the fluidic manipulation device 100 and fluidically coupled between a corresponding first inlet port 111 and an associated first valve 102-1 disposed right above the first inlet channel 211 along the Z direction. Each first valve 102-1 is fluidically coupled between an associated first inlet port 111 and the first common channel 212, through the corresponding first inlet channel 211. In some embodiments, each first inlet port 111 is configured to receive a wet liquid reagent that contains water. When a first valve 102-1 is open, it allows the wet liquid reagent to flow from the corresponding first inlet port 111 right below the first valve 102-1 along the Z direction, through the corresponding first inlet channel 211 right above the first inlet port 111 and right below the first valve 102-1 along the Z direction, and to the first common channel 212, e.g. due to a pressure difference driven by a pressured inert gas. As shown in FIGS. 2A-2C, the first common channel 212 is shared by all first inlet ports in the first input section 110.

As shown in FIG. 2A and FIG. 2C, the second input section 120 includes a plurality of second inlet channels 221 each corresponding to and connecting to one of the second inlet ports 121. Each second inlet channel 221 extends vertically along the Z direction in the fluidic manipulation device 100 and fluidically coupled between a corresponding second inlet port 121 and an associated second valve 102-2 disposed right above the second inlet channel 221 along the Z direction. Each second valve 102-2 is fluidically coupled between an associated second inlet port 121 and the second common channel 222, through the corresponding second inlet channel 221. In some embodiments, each second inlet port 121 is configured to receive a dry liquid reagent. When a second valve 102-2 is open, it allows the dry liquid reagent to flow from the corresponding second inlet port 121 right below the second valve 102-2 along the Z direction, through the corresponding second inlet channel 221 right above the second inlet port 121 and right below the second valve 102-2 along the Z direction, and to the second common channel 222, e.g. due to a pressure difference driven by a pressured inert gas. As shown in FIGS. 2A-2C, the second common channel 222 is shared by all second inlet ports in the second input section 120. For the convenience of description, the first input section 110 and the second input section 120 are used for wet reagents and dry reagents, respectively. However, this does not limit the scope of the uses of these two sections. The two sections 110 and 120 can be used for reagents of different natures, which cannot be mixed during the delivery stage and before delivered to a reaction chamber. For example, the first input section 110 and the second input section 120 are used for dry reagents and wet reagents, respectively.

As shown in FIG. 2A and FIG. 2B, the output section 130 includes a plurality of outlet channels 231 each corresponding to and connecting to one of the outlet ports 131. Each outlet channel 231 extends vertically along the Z direction in the fluidic manipulation device 100 and fluidically coupled between a corresponding outlet port 131 and an associated third valve 102-3 disposed right above the outlet channel 231 along the Z direction. Each third valve 102-3 is fluidically coupled between an associated outlet port 131 and the third common channel 232, through the corresponding outlet channel 231. When a third valve 102-3 is open, it allows a liquid reagent to flow from the third common channel 232, through the corresponding outlet channel 231 right below the third valve 102-3 along the Z direction, and to the corresponding outlet port 131 right below the outlet channel 231 along the Z direction, e.g. due to a pressure difference driven by a pressured inert gas. As shown in FIGS. 2A-2C, the third common channel 232 is shared by all outlet ports in the output section 130.

As shown in FIG. 2A to FIG. 2C, while the first common channel 212 is a single continuous and straight tube extending through the two blocks 105-1, 105-2 (FIG. 1B) in the first input section 110, the two blocks 105-1, 105-2 in the first input section 110 are connected and integrated using fasteners 104 and flange seals 204. While the second common channel 222 is a single continuous and straight tube extending through the two blocks 105-4, 105-5 (FIG. 1B) in the second input section 120, the two blocks 105-4, 105-5 in the second input section 120 are connected and integrated using fasteners 104 and flange seals 204. Similarly, the first input section 110 is connected and integrated to the output section 130 using fasteners 104 and flange seals 204; and the second input section 120 is also connected and integrated to the output section 130 using fasteners 104 and flange seals 204.

In some embodiments, all channels including the first inlet channels 211, the second inlet channels 221, the third inlet channels 231, the first common channel 212, the second common channel 222, and the third common channel 232, have a same cross sectional area (e.g. a cross-sectional area between 0.1 square millimeters and 10 square millimeters) and a same inner diameter. In some embodiments, liquid flowing in each channel of the first inlet channels 211, the second inlet channels 221, the third inlet channels 231, the first common channel 212, the second common channel 222, and the third common channel 232, is sealed from atmosphere and driven by a pressurized inert gas.

The first shutoff valve 102-4 is fluidically coupled between the first common channel 212 and the third common channel 232. When the first shutoff valve 102-4 is open, it allows a wet fluid reagent to flow from the first common channel 212 to the third common channel 232. The second shutoff valve 102-5 is fluidically coupled between the second common channel 222 and the third common channel 232. When the second shutoff valve 102-5 is open, it allows a dry fluid reagent to flow from the second common channel 222 to the third common channel 232.

In some embodiments, the wet liquid is selected from the wet group consisting of oxidizer (OX), Cap A, Cap B and an electro-chemical reaction medium (Echem); and the dry liquid is selected from the dry group consisting of amidites, activator and inert gas.

As shown in FIG. 2A to FIG. 2C, the first inlet ports 111, the first inlet channels 211, the first common channel 212, the first valves 102-1, and the first shutoff valve 102-4 are integrated in the first input section 110 of the fluidic manipulation device 100; the second inlet ports 121, the second inlet channels 221, the second common channel 222, the second valves 102-2, and the second shutoff valve 102-5 are integrated in the second input section 120 of the fluidic manipulation device 100; the outlet ports 131, the outlet channels 231, the third common channel 232 and the third valves 102-3 are integrated in the output section 130 of the fluidic manipulation device 100. The output section 130 is physically coupled between the first input section 110 and the second input section 120. The first input section 110 and the second input section 120 are segregated from each other. In some embodiments, the device 100 as shown in FIGS. 1A-1B and 2A-2C further comprises a controller (not shown) such a control panel configured to be connected a computer by wires or wirelessly, or is configured to a controller such as a control panel or a computer.

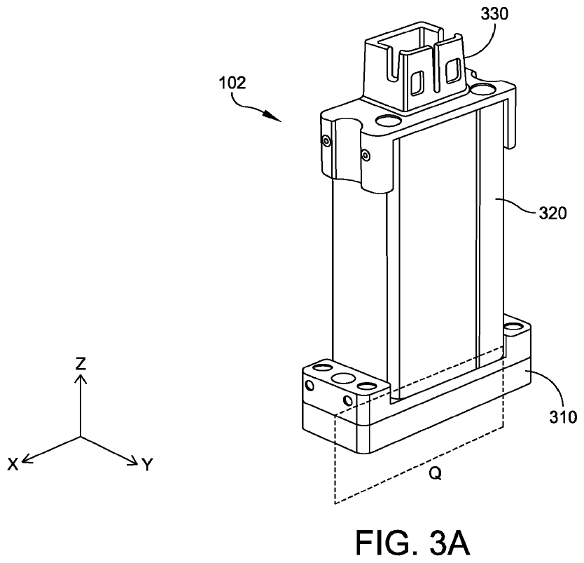

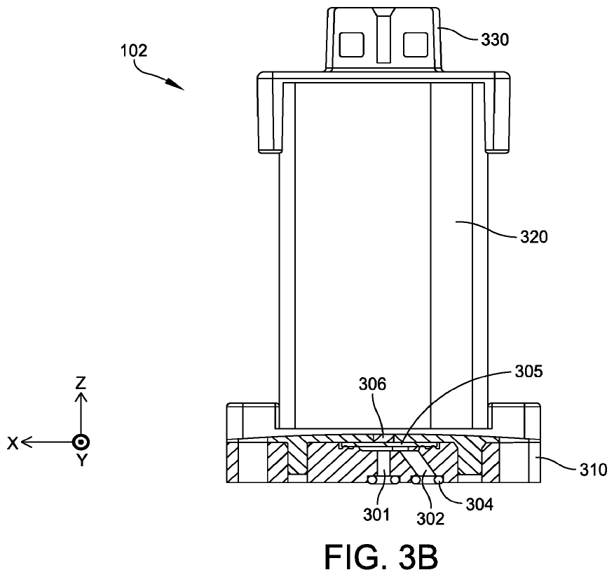

As shown in FIG. 2A, the first common channel 212, the second common channel 222, and all outlet channels 231 (and hence all outlet ports 131) are all aligned up along the straight line A-A′; while the third common channel 232, all first inlet channels 211, and all second inlet channels 221 (and hence all first inlet ports 111 and all second inlet ports 121) are all aligned up along the straight line B-B′. The offset between the straight line A-A′ and the straight line B-B′ corresponds to a connection of the first ports and the second ports as described in FIG. 3B.

In some embodiments, all valves 102 including the plurality of first valves 102-1, the plurality of second valves 102-2, the plurality of third valves 102-3, the first shutoff valve 102-4, and the second shutoff valve 102-5, have a same structure and a same orifice diameter. Each valve can be implemented as any valve that is chemically compatible with the reagents of interest and has adequate dynamic response for the fluidic reagent delivery.

FIG. 3A illustrates an exemplary perspective view of an exemplary valve in a fluidic manipulation device 100, in accordance with some embodiments of the present disclosure. FIG. 3B illustrates an exemplary side and cross-sectional view of the valve shown in FIG. 3A, in accordance with some embodiments of the present disclosure. In some embodiments, the valve shown in FIG. 3A and FIG. 3B may serve as any of the valves 102 in FIGS. 1-2.

As shown in FIG. 3A, the valve 102 includes a valve body 310, a coil housing 320 on the valve body 310, and a connection head 330 on the coil housing 320. The valve body 310 may include some plastic material that has high chemical resistance. The coil housing 320 may include coil and/or some electrical circuit structure to generate magnetic force. The connection head 330 may include pins for connecting the valve 102 to a control panel using a wire or other connection methods. In some embodiments, the control panel may be connected to all of the valves 102 of the fluidic manipulation device 100, and also connected to a control computer. As such, the operation of the fluidic manipulation device 100 can be controlled based on a firmware or software running on the control computer.

In some embodiments, the side and cross-sectional view in FIG. 3B can be obtained by cutting the valve body 310 of the valve 102 in FIG. 3A along the plane Q in the Z direction, and looking from the side of the valve 102 along the −Y direction. As shown in FIG. 3B, the valve body 310 includes a first port 301 that comprises a vertical channel, a second port 302 that comprises an inclined channel, and a movable membrane 305 that is disposed above both the first port 301 and the second port 302. The valve body 310 also includes a metal weight block 306 on the movable membrane 305. In some embodiments, each valve 102 is integrated to the plastic base 101 using flange seals 304 and some fasteners on both sides of the valve 102 along the X direction.

Depending on the implementation, either one of the first port 301 and the second port 302 can be an input port, while the other one can be an output port accordingly. In the example shown in FIGS. 2A-2C, all of the first ports 301 of the valves 102 are aligned up along the line B-B′ in FIG. 2A; and all of the second ports 302 of the valves 102 are aligned up along the line A-A′ in FIG. 2A. As such, in the first input section 110, a first port 301 of each first valve 102-1 is an input port of the first valve 102-1, as the first port 301 is directly connected or integrated to a first inlet channel 211 of a corresponding first inlet port 111 (e.g. using fasteners and flange seals). Accordingly, a second port 302 of each first valve 102-1 in the first input section 110 is an output port of the first valve 102-1, as the second port 302 is fluidically connected or integrated to the first common channel 212 in the first input section 110.

Similarly, in the second input section 120, a first port 301 of each second valve 102-2 is an input port of the second valve 102-2, as the first port 301 is directly connected or integrated to a second inlet channel 221 of a corresponding second inlet port 121 (e.g. using fasteners and flange seals). Accordingly, a second port 302 of each second valve 102-2 in the second input section 120 is an output port of the second valve 102-2, as the second port 302 is fluidically connected or integrated to the second common channel 222 in the second input section 120.

In the output section 130, a first port 301 of each third valve 102-3 is an input port of the third valve 102-3, as the first port 301 is fluidically connected or integrated to the third common channel 232 in the output section 130. Accordingly, a second port 302 of each third valve 102-3 in the output section 130 is an output port of the third valve 102-3, as the second port 302 is directly connected or integrated to an outlet channel 231 of a corresponding outlet port 131 (e.g. using fasteners and flange seals).

Specially, a first port 301 of the first shutoff valve 102-4 (FIGS. 2B-2C) is an output port of the first shutoff valve 102-4, as the first port 301 is fluidically connected or integrated to the third common channel 232. Accordingly, a second port 302 of the first shutoff valve 102-4 is an input port of the first shutoff valve 102-4, as the second port 302 is fluidically connected or integrated to the first common channel 212.

Similarly, a first port 301 of the second shutoff valve 102-5 is an output port of the second shutoff valve 102-5, as the first port 301 is fluidically connected or integrated to the third common channel 232. Accordingly, a second port 302 of the second shutoff valve 102-5 is an input port of the second shutoff valve 102-5, as the second port 302 is fluidically connected or integrated to the second common channel 222.

FIG. 3B is showing a closed state of the valve 102, where a pressure generated by the coils in the coil housing 320 and/or by the weight of the metal weight block 306 itself is applied onto the movable membrane 305. Therefore, the movable membrane 305 is pushed down to cover the first port 301 and the second port 302, such that the first port 301 and the second port 302 are not fluidically coupled to each other. That is, a liquid in the input port of the first port 301 and the second port 302 cannot flow into the output port of the first port 301 and the second port 302.

When the valve 102 is switched to an open state (e.g. based on a control signal sent by the control computer through the control panel), no pressure is applied onto the metal weight block 306 (or there is even an attraction to lift up the metal weight block 306). Then, fluid in the input port will give pressure from the bottom of the movable membrane 305 to push up the movable membrane 305 and the metal weight block 306, such that the fluid can flow from the input port to the output port.

In one example, one of the first valves 102-1, when open, allows a wet liquid to flow from an associated first inlet port 111, through a corresponding first inlet channel 211, through the first valve 102-1, to the first common channel 212. The first shutoff valve 102-4, when open, allows the wet liquid to flow from the first common channel 212, through the first shutoff valve 102-4, to the third common channel 232. Then one of the third valves 102-3, when open, allows the wet liquid to flow from the third common channel 232, through the third valve 102-3, through a corresponding outlet channel 231, to an associated outlet port 131. The wet liquid will then be delivered to a target chamber connected to the associated outlet port 131.

In another example, one of the second valves 102-2, when open, allows a dry liquid to flow from an associated second inlet port 121, through a corresponding second inlet channel 221, through the second valve 102-2, to the second common channel 222. The second shutoff valve 102-5, when open, allows the dry liquid to flow from the second common channel 222, through the second shutoff valve 102-5, to the third common channel 232. Then one of the third valves 102-3, when open, allows the dry liquid to flow from the third common channel 232, through the third valve 102-3, through a corresponding outlet channel 231, to an associated outlet port 131. The dry liquid will then be delivered to a target chamber connected to the associated outlet port 131.

In some embodiments, the cross sectional area of the fluidic flow path is kept uniform to the extent of manufacturing capabilities. Specifically, the inner diameters of all inlet/outlet channels 211, 221, 231, the inner diameters of all common channels 212, 222, 232, the orifice diameters of all valves 102, the interconnect hole diameters of the fluidic manipulation device 100 are all closely matched. Therefore, there is little sudden expansion or contraction of the fluidic path, causing pressure and flow rate variation.

In some embodiments, the fluidic manipulation device 100 has an internal reagent volume between 1 and 100 milliliters (mL), where the cross sectional area of the channels in the fluidic manipulation device 100 is between 0.1 to 10 square millimeters (mm²). A channel, e.g. the first common channel 212, the second common channel 222, or the third common channel 232, in the fluidic manipulation device 100 can be formed by digging holes from two opposite sides of a plastic block. The channel will not collapse during digging. The holes (e.g. with a diameter of 1 mm) from the two sides need to be aligned to each other.

It would not work by just reducing the scale of a device utilized for a larger-scale fluid distribution. Because a fluidic device with a larger internal volume, e.g. 1~100 L, does not need to care about a small amount (e.g. 100 mL) of dead reagent or waste during the distribution. Using the same design (e.g. connecting metal tubes with inner diameters of ⅜ and ½ inches, e.g. by connectors or welding) as a larger-scale fluidic device would generate a big and unacceptable percentage of dead reagent, e.g. 100 mL dead reagent per every 300 mL transferred reagent. In addition, it is very difficult if not impossible to connect or weld together side metal channels with a close distance (e.g. 7.5 mm between two adjacent side channels), for a scale (1~100 mL internal volume and 0.1~10 mm²) of the fluidic manipulation device 100.

It would not work by just increasing the scale of a device utilized for a smaller-scale fluid distribution, either. A fluidic device with a smaller scale has channels with inner diameter at 10~100 μm, where the channels are connected by pouring polydimethylsiloxane silicone into a mold (e.g. 4~5 inches). But it is very difficult if not impossible to pour polydimethylsiloxane silicone into a mold with a larger scale (e.g. >10 inches), because a channel built in this way with a larger size could easily collapse.

In some embodiments, each valve has an orifice diameter of 0.7~1 mm (e.g. 0.8 mm); and has a station width of about 7~8 mm (e.g. 7.2 mm), which is the minimum station-to-station (center-to-center) spacing allowed. The flange interface for the fluidic manipulation device 100 may be designed according to the manufacturer recommendation.

In some embodiments, a simple implementation of a common channel connecting all the output of these valves 102 would be about 166 mm long, resulting in approximately 150:1~200:1 aspect ratio (channel length:channel inner diameter). Drilling a hole at this scale is impossible to be accurate without channel collapse. It was determined that the maximum drilling depth for a 1.0 mm hole is 40 mm for the required precision. Therefore, the fluidic manipulation device 100 comprises five blocks: a 3-station block and a 5-station block forming the first input section 110; a 5-station block and a 6-station block forming the second input section 120; and a 6-station block forming the output section 130.

Every two adjacent manifold blocks are sealed around with O-rings having high temperature and ultimate chemical resistance. In some embodiments, each O-ring has an inner diameter of about 1 mm (e.g. 1.07 mm). In some embodiments, there is no additional retaining structure inside the O-ring, allowing the O-ring to form a long channel with almost no variation in cross section. In some embodiments, the operation compression of the O-ring is about 24%.

The two shutoff valves 102-4, 102-5 are integrated in the fluidic manipulation device 100 to segregate the inputs and prevent the reagent from one group contaminating the other group. For example, when a wet reagent is flowing towards the outlets, it will not flow through the dry-side shutoff valves, therefore not contaminating the dry reagent inlets. In addition, integrating the shutoff valves into the fluidic manipulation device 100 as described above can greatly reduce the internal volume of the fluidic manipulation device 100, while keep the dead reagent percentage low.

The embodiments shown in FIGS. 1-3 use at least 23 valve stations. In other embodiments, the block number can be easily increased. For example, 2 blocks in the first input section 110 and the second input section 120 can be easily expanded to 3 or more blocks. In some embodiment, the station numbers per block is topped at 6 stations due to the fabrication limitations described.

In general, the fluidic manipulation device 100 is a reagent distribution manifold that can be used in any fluid distribution application with multiple inlets and multiple outlets, e.g. bio-reactor, chemical synthesis, or other microfluidic chips.

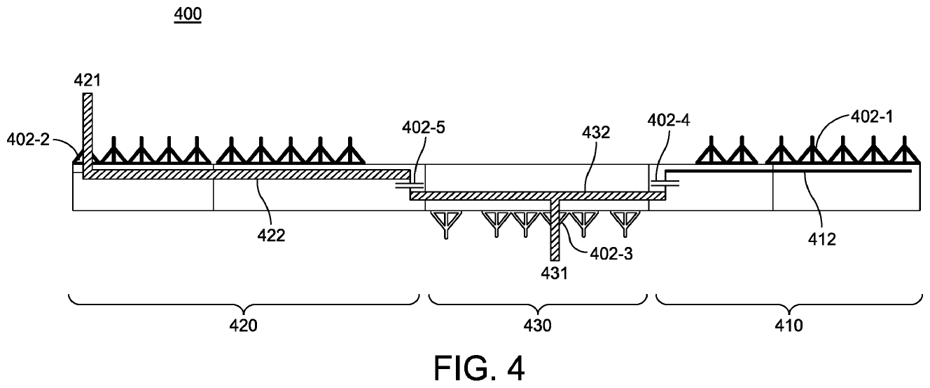

FIG. 4 illustrates a barebone diagram of a fluidic manipulation manifold 400, in accordance with some embodiments of the present disclosure. In some embodiments, the manifold 400 may have a structure as the fluidic manipulation device 100 in FIG. 1A and FIG. 1B. As shown in FIG. 4, the manifold 400 includes a wet-side input section 410 configured to receive wet fluids via inlet ports, inlet valves 402-1, and the wet-side common channel 412. The manifold 400 also includes a dry-side input section 420 configured to receive dry fluids via inlet ports, inlet valves 402-2, and the dry-side common channel 422. In addition, the manifold 400 also includes an output section 430 configured to receive wet fluids from the wet-side input section 410 via a shutoff valve 402-4, receive dry fluids from the dry-side input section 420 via a shutoff valve 402-5, and output each received fluid via outlet common channel 432, an outlet valve 402-3, to a target chamber via a corresponding outlet. In some embodiments, the sections 410 and 420 in FIG. 4 correspond to the sections 110 and 120 in FIGS. 1-3, respectively.

FIG. 4 also shows an exemplary fluidic pathway when activating one inlet 421 in the dry-side input section 420 and activating one outlet 431 in the output section 430. In some embodiments, the valves on the intended fluidic pathway are all opened, while the other valves are all closed. For example, regarding the fluidic pathway (referred to as the bold lines) in FIG. 4, the inlet valve 402-2, the shutoff valve 402-5, and the outlet valve 402-3 where the fluidic pathway passes through are all opened, while all other valves including the shutoff valve 402-4 are all closed.

Following the fluidic pathway (referred to as the bold lines) in FIG. 4, a dry fluid flows into the fluidic manifold via the activated inlet 421, flowing through the opened inlet valve 402-2 to the dry-side common channel 422, then flowing through the opened shutoff valve 402-5 to the outlet common channel 432, then flowing through the opened outlet valve 402-3 to the activated outlet 431. The dry fluid may then flow to some target chamber via the activated outlet 431. Because the shutoff valve 402-4 is closed, the dry fluid can only flow to the end of the outlet common channel 432, but cannot flow into the wet-side common channel 412.

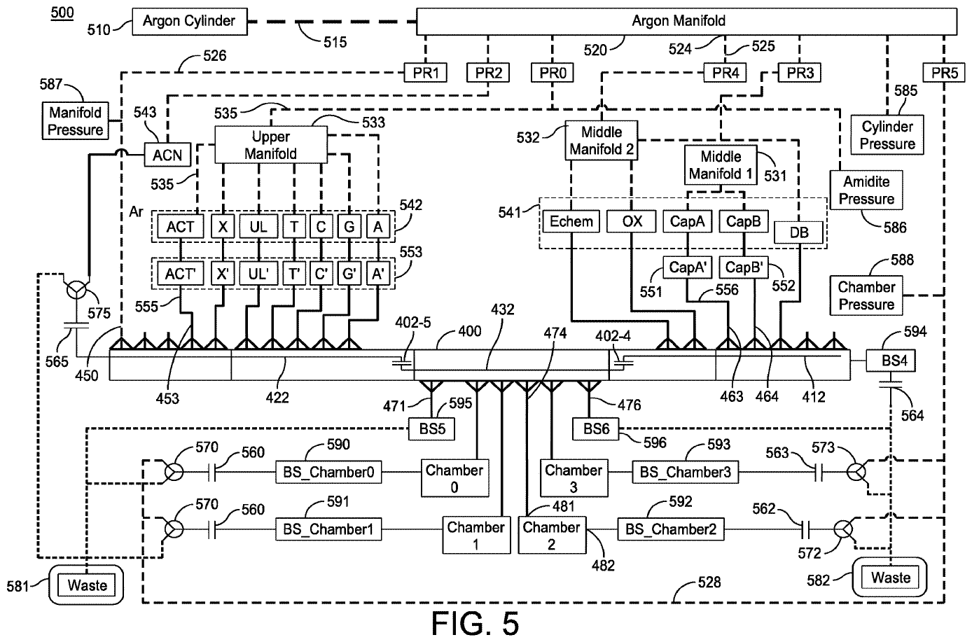

FIG. 5 illustrates an exemplary diagram of a reagent delivery system 500 including the fluidic manifold 400 as shown in FIG. 4, in accordance with some embodiments of the present disclosure. The reagent delivery system 500 is a pressure driven reagent delivery system that utilizes inert gas to prevent atmospheric contamination. In some embodiments, the pressurized inert gas pushes a reagent through the fluidic manifold 400 into a target chamber. The target chamber is fully filled when the chamber outlet is brought to atmospheric pressure. The process is stopped when the bubble sensor positioned at the chamber outlet detects transition from gas to liquid. Pressure sensors are positioned at the pressurized gas side to monitor the gas pressure, such that consistent and stable pressure difference can be achieved for the flow and software control.

As shown in FIG. 5, the reagent delivery system 500 includes: a plurality of wet reagent containers 541 each containing a respective wet liquid reagent that includes water; a plurality of dry reagent containers 542 each containing a respective dry liquid reagent that does not include water or contains only trace amount of moisture; an inert gas source 510 configured to provide a pressurized inert gas; and an inert gas manifold 520 coupled to the inert gas source 510. In this example, the inert gas is argon; the inert gas source 510 is an argon cylinder; and the inert gas manifold 520 is an argon manifold. While in other examples, the pressurized inert gas may be any other inert gas, like nitrogen, helium, etc.; the inert gas source 510 may be a source or container for any inert gas; and the inert gas manifold 520 may be a manifold for the inert gas provided by the inert gas source 510. The inert gas manifold 520 is configured to distribute the pressurized inert gas to the plurality of wet reagent containers 541 and the plurality of dry reagent containers 542.

As shown in FIG. 5, the reagent delivery system 500 also includes the fluidic manipulation manifold 400. In some embodiments, the fluidic manipulation manifold 400 in FIG. 5 is a fluidic device that has a same structure as the fluidic manipulation device 100 as described with respect to FIGS. 1-3. For example, the fluidic manipulation manifold 400 may comprise a plurality of first inlet ports, a plurality of second inlet ports, and a plurality of outlet ports. Each of the plurality of wet reagent containers 541 is fluidically coupled to one of the plurality of first inlet ports; and each of the plurality of dry reagent containers 542 is fluidically coupled to one of the plurality of second inlet ports. For example, the wet reagent containers containing Cap A and Cap B respectively in the wet reagent containers 541 are fluidically coupled to the first inlet ports 463, 464, respectively, of the fluidic manipulation manifold 400. For example, the dry reagent container containing activator (ACT) in the dry reagent containers 542 is fluidically coupled to the second inlet port 453 of the fluidic manipulation manifold 400.

As shown in FIG. 5, the reagent delivery system 500 also includes a plurality of bubble sensors 590, 591 . . . 596; and a plurality of chambers: Chamber 0, Chamber 1, Chamber 2, Chamber 3. Each chamber comprises two chamber ports: a first chamber port and a second chamber port. The first chamber port of each chamber is fluidically coupled to one of the plurality of outlet ports of the manifold 400; and the second chamber port of each chamber is fluidically coupled to one of the plurality of bubble sensors 590, 591 . . . 596. For example, Chamber 2 has a first chamber port 481 and a second chamber port 482. While the first chamber port 481 is fluidically coupled to the outlet port 474 of the fluidic manipulation manifold 400, the second chamber port 482 is fluidically coupled to the bubble sensor 592.

As shown in FIG. 5, the inert gas manifold 520 has an inlet coupled to the inert gas source 510 via a first plastic tube 515; and the inert gas manifold 520 has a plurality of outlets. The reagent delivery system 500 also includes a plurality of pressure regulators PR0, PR1 . . . PR5, each of which is fluidically coupled to one of the plurality of outlets of the inert gas manifold 520 via a second plastic tube. An inner diameter of the first plastic tube 515 is larger than an inner diameter of the second plastic tube. For example, the inert gas manifold 520 has an outlet 524 that is fluidically coupled to the pressure regulator PR4 via the second plastic tube 525, where an inner diameter of the first plastic tube 515 is larger than an inner diameter of the second plastic tube 525. In some embodiments, the inner diameter of the first plastic tube 515 is about ¼ inch; while the inner diameter of each second plastic tube is about ⅛ inch.

In some embodiments, the reagent delivery system 500 includes: at least one dry-side manifold that is fluidically coupled, via third plastic tubes, between at least one of the plurality of outlets of the inert gas manifold 520 and the plurality of dry reagent containers 542; and at least one wet-side manifold that is fluidically coupled, via third plastic tubes, between at least one of the plurality of outlets of the inert gas manifold 520 and the plurality of wet reagent containers 541. In some embodiments, each third plastic tube has an inner diameter same as that of the second plastic tube. In the example shown in FIG. 5, the reagent delivery system 500 includes: a first wet-side manifold 531, a second wet-side manifold 532, and a dry-side manifold 533. The dry-side manifold 533 is fluidically coupled, via the third plastic tubes 535 and the pressure regulator PR0, between one of the plurality of outlets of the inert gas manifold 520 and all of the dry reagent containers 542. The dry-side manifold 533 is configured to receive pressured inert gas from the inert gas manifold 520 via the pressure regulator PR0, and distribute the received pressured inert gas to all of the dry reagent containers 542, to push the dry reagents in the dry reagent containers 542 to respective inlet ports of the manifold 400. In some embodiments, each third plastic tubes 535 has an inner diameter of ⅛ inch, same as that of the second plastic tube 525.

Similarly, the first wet-side manifold 531 is fluidically coupled, via third plastic tubes, between one of the plurality of outlets of the inert gas manifold 520 and two wet reagent containers containing Cap A and Cap B, respectively. The second wet-side manifold 532 is fluidically coupled, via third plastic tubes, between one of the plurality of outlets of the inert gas manifold 520 and three wet reagent containers containing Echem, OX and trichloroacetic acid deblock (DB), respectively. Each of the first wet-side manifold 531 and the second wet-side manifold 532 is configured to receive pressured inert gas from the inert gas manifold 520 and distribute the received pressured inert gas to corresponding wet reagent containers 541, to push the wet reagents in the wet reagent containers 541 to respective inlet ports of the manifold 400.

In some embodiments, each of the plurality of dry reagent containers 542 is fluidically coupled, via a fourth plastic tube, to a corresponding second inlet port of the manifold 400; and each of the plurality of wet reagent containers 541 is fluidically coupled, via a fifth plastic tube, to a corresponding first inlet port of the manifold 400. The fourth plastic tube has an inner diameter same as that of the fifth plastic tube. In one example, the dry reagent container ACT containing an activator is fluidically coupled, via a fourth plastic tube 555, to a corresponding second inlet port 453 of the manifold 400. In another example, the wet reagent container CapA containing Cap A is fluidically coupled, via a fifth plastic tube 556, to a corresponding first inlet port 463 of the manifold 400. In some embodiments, both the fourth plastic tube 555 and the fifth plastic tube 556 have a same inner diameter of ⅛ inch. In other embodiments, both the fourth plastic tube 555 and the fifth plastic tube 556 have a same inner diameter of 1/16 inch. In other embodiments, both the fourth plastic tube 555 and the fifth plastic tube 556 have an inner diameter changing from ⅛ inch at a portion close to the reagent container to 1/16 inch at a portion close to the corresponding inlet ports of the manifold 400. In the example shown in FIG. 5, the dry reagent containers 542 also include containers containing: Amidite X (X), Universal Linker (UL), Amidite T (T), Amidite C (C), Amidite G (G), Amidite A (A), respectively.

For each reagent container of the wet reagent containers 541 and the dry reagent containers 542, a pressure of the inert gas can force the fluid reagent in the reagent container to flow to the manifold 400. The chamber outlets are brought to atmospheric pressure during a filling process to generate the pressure difference needed for the flow. The flow rate may be determined by the pressure of the inert gas, the pressure of the chamber outlet of the target chamber (during a filling process), and the fluidic resistance experienced by the fluid reagent when flowing through the tubes and channels in the reagent delivery system 500.

As shown in FIG. 5, the reagent delivery system 500 also includes a plurality of dry flow sensors 553 each of which is coupled to a fourth plastic tube connecting a dry reagent container 542 and its corresponding second inlet port of the manifold 400, and is configured to monitor a flow rate of the respective dry liquid reagent flowing from the dry reagent container 542 to the corresponding second inlet port. For example, a dry flow sensor ACT′ 553 is coupled to the fourth plastic tube 555 connecting a dry reagent container ACT 542 and its corresponding second inlet port 453 of the manifold 400. In some embodiments, the dry flow sensor ACT′ 553 may be coupled to the fourth plastic tube 555 in a non-invasive way without affecting the flowing of the fluid in the fourth plastic tube 555. As such, the dry flow sensor ACT′ 553 can monitor the flow rate of the activator flowing from the dry reagent container ACT 542 to the corresponding second inlet port 453.

The reagent delivery system 500 also includes a plurality of wet flow sensors 551, 552 each of which is coupled to a fifth plastic tube connecting a wet reagent container 541 and its corresponding first inlet port of the manifold 400, and is configured to monitor a flow rate of the respective wet liquid reagent flowing from the wet reagent container 541 to the corresponding first inlet port. For example, a wet flow sensor CapA′ 551 is coupled to the fifth plastic tube 556 connecting the wet reagent container CapA 541 and its corresponding first inlet port 463 of the manifold 400. In some embodiments, the wet flow sensor CapA′ 551 may be coupled to the fifth plastic tube 556 in a non-invasive way without affecting the flowing of the fluid in the fifth plastic tube 556. As such, the wet flow sensor CapA′ 551 can monitor the flow rate of the Cap A flowing from the wet reagent container CapA 541 to the corresponding first inlet port 463. In some embodiments, all the containers containing reagents that might need to mix with another reagent should be coupled to a flow sensor via the corresponding plastic tube. As such, one can monitor whether the mix is according to a predetermined ratio, e.g. 1:1 or 50%: 50%. For example, each of the amidites may be mixed with the activator (ACT); Cap A and Cap B solutions may be mixed together. In some embodiments, the container of universal linker (UL) is not coupled to any flow sensor due to volume and tubing size constraints.

In some embodiments, the outlet ports of the manifold 400 are arranged in a row on one side of the manifold 400. As shown in FIG. 5, a first outlet port 471 arranged at one end of the row is directly coupled to a bubble sensor 595 without any chamber disposed therebetween; and a second outlet port 476 arranged at the other end of the row is directly coupled to a bubble sensor 596 without any chamber disposed therebetween. Both the bubble sensor 595 and the bubble sensor 596 are configured to monitor the fluid flow in the outlet common channel 432 of the manifold 400. In one example, when the shutoff valve 402-5 is open and the shutoff valve 402-4 is closed, the bubble sensor 596 can indicate whether the outlet common channel 432 is full of a dry fluid, where the outlet common channel 432 is full when there is no additional bubble present at the bubble sensor 596. In another example, when the shutoff valve 402-5 is closed and the shutoff valve 402-4 is open, the bubble sensor 595 can indicate whether the outlet common channel 432 is full of a wet fluid, where the outlet common channel 432 is full when there is no additional bubble present at the bubble sensor 595.

As shown in FIG. 5, the reagent delivery system 500 also includes a first waste container 581 coupled to the bubble sensor 595; and a second waste container 582 coupled to the bubble sensor 596. The reagent flowing from the outlet port 471 to the bubble sensor 595 is treated as a waste and collected by the first waste container 581. Similarly, the reagent flowing from the outlet port 476 to the bubble sensor 596 is treated as a waste and collected by the second waste container 582. In some embodiments, the first waste container 581 and the second waste container 582 always have a pressure at the atmosphere pressure.

As shown in FIG. 5, the reagent delivery system 500 also includes: a plurality of first two-way valves 560, 561, each coupled between a respective one of the bubble sensors 590, 591 and the first waste container 581; and a plurality of second two-way valves 562, 563 each coupled between a respective one of the bubble sensors 592, 593 and the second waste container 582. In addition, the reagent delivery system 500 also includes: a plurality of first three-way valves 570, 571; and a plurality of second three-way valves 572, 573. The three-way valve 570 has a first end coupled to the two-way valve 560, and a second end switchable between the first waste container 581 and the pressure regulator PR5 that is fluidically coupled to one of the plurality of outlets of the inert gas manifold 520. The three-way valve 571 has a first end coupled to the two-way valve 561, and a second end switchable between the first waste container 581 and the pressure regulator PR5 that is fluidically coupled to one of the plurality of outlets of the inert gas manifold 520. The three-way valve 572 has a first end coupled to the two-way valve 562, and a second end switchable between the second waste container 582 and the pressure regulator PR5 that is fluidically coupled to one of the plurality of outlets of the inert gas manifold 520. The three-way valve 573 has a first end coupled to the two-way valve 563, and a second end switchable between the second waste container 582 and the pressure regulator PR5 that is fluidically coupled to one of the plurality of outlets of the inert gas manifold 520.

Each of the bubble sensors 590, 591, 592, 593 is configured to monitor the liquid fluid in a correspondingly connected chamber, and indicate when the connected chamber is full. The fluid flowing from the connected chamber to the corresponding bubble sensor is treated as a waste and is collected by the corresponding waste container. In one example, the bubble sensor 592 can indicate whether the liquid fluid is full in the Chamber 2, where the Chamber 2 is fully filled with the liquid fluid when there is no additional bubble present at the bubble sensor 592. The liquid fluid flowing from the Chamber 2 to the bubble sensor 592 is treated as a waste and is collected by the waste container 582, via the two-way valve 562 and the three-way valve 572.

As shown in FIG. 5, the reagent delivery system 500 also includes a washing liquid container 543 containing a washing liquid configured to wash channels, valves and ports of the manifold 400. The washing liquid container 543 is coupled between the pressure regulator PR2 and the second common channel 422 of the manifold 400. In the example shown in FIG. 5, the washing liquid is acetonitrile (ACN). In other examples, the washing liquid in the washing liquid container 543 may be water, ethanol, methanol, acetone, hexane, benzene, and/or acetic acid. The washing liquid is a solvent or a solvent mixture. Acetonitrile (ACN) is an exemplary washing liquid described herein and in FIGS. 5-10.

As shown in FIG. 5, the reagent delivery system 500 also includes: a two-way valve 565 coupled between the washing liquid container 543 and the second common channel 422; and a three-way valve 575 having: a first end coupled to the two-way valve 565, and a second end switchable between the first waste container 581 and the washing liquid container 543.

As shown in FIG. 5, the reagent delivery system 500 also includes: a bubble sensor 594 coupled between the first common channel 412 and the second waste container 582; and a two-way valve 564 coupled between the bubble sensor 594 and the second waste container 582.

In some embodiments, the reagent delivery system 500 also includes pressure sensors 585, 586, 587, 588. As shown in FIG. 5, a gas tube 526 is coupled between the pressure regulator PR1 and a second inlet port 450 that is located at an end of the manifold 400. The gas tube 526 is configured to transport the pressurized inert gas from the pressure regulator PR1 to the second inlet port 450 to purge the manifold 400. In this example, the inert gas is argon, while the inert gas can be nitrogen or helium in other examples. In some embodiments, the pressure sensor 587 is coupled to the gas tube 526 and configured to monitor a pressure of gas blowing into the manifold 400.

As shown in FIG. 5, the reagent delivery system 500 also includes a gas tube 528 that is coupled between the pressure regulator PR5 and each of three-way valves 570, 571, 572, 573. The gas tube 528 is configured to transport the pressurized inert gas from the pressure regulator PR5 to at least one of plurality of chambers (Chambers 0-3) to purge the at least one chamber. In some embodiments, the pressure sensor 588 is coupled to the gas tube 528 and configured to monitor a pressure of gas blowing into the at least one chamber.

In some embodiments, the pressure sensor 585 is directly coupled to one of the plurality of outlets of the inert gas manifold 520 without any pressure regulator disposed therebetween, and is configured to monitor a pressure of gas blowing out of the inert gas source 510 and/or the inert gas manifold 520. In some embodiments, the fourth pressure sensor 586 is coupled between the pressure regulator PR0 and the dry-side manifold 533 fluidically coupled to the plurality of dry reagent containers 542, and is configured to monitor a pressure of gas blowing into the plurality of dry reagent containers 542.

In some embodiments, each of the plurality of pressure sensors 585, 586, 587, 588 is configured to control a pressure and/or blowing rate of the pressurized inert gas using a program based on feedback information from at least one of the plurality of bubble sensors 590, 591 . . . 596. In some embodiments, the pressure of the inert gas going into the reagent containers 541, 542 is higher than the atmospheric pressure, e.g. by 8 psi. In some embodiments, the feedback information is also used to control at least one valve in the reagent delivery system 500.

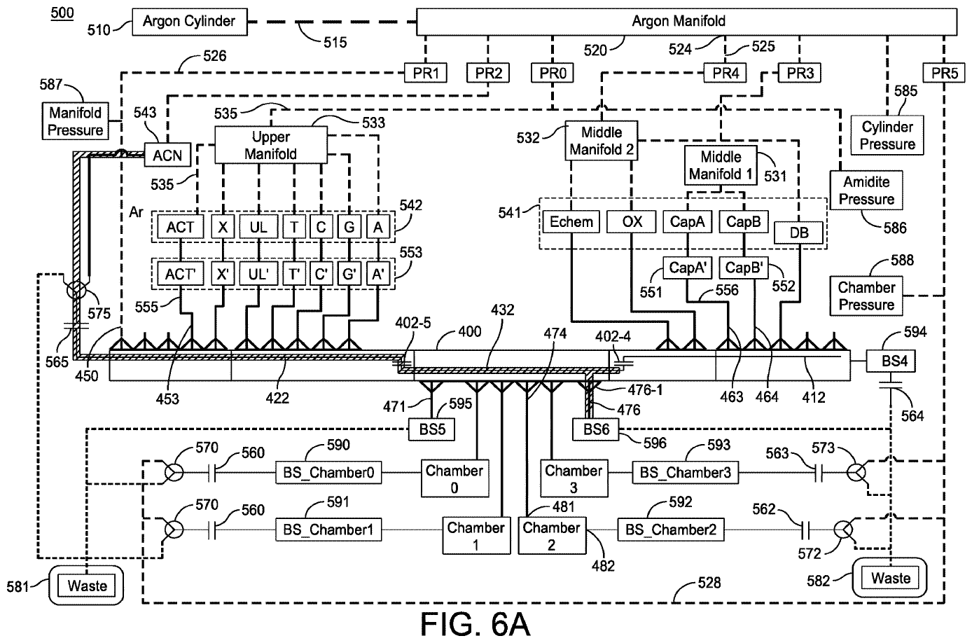

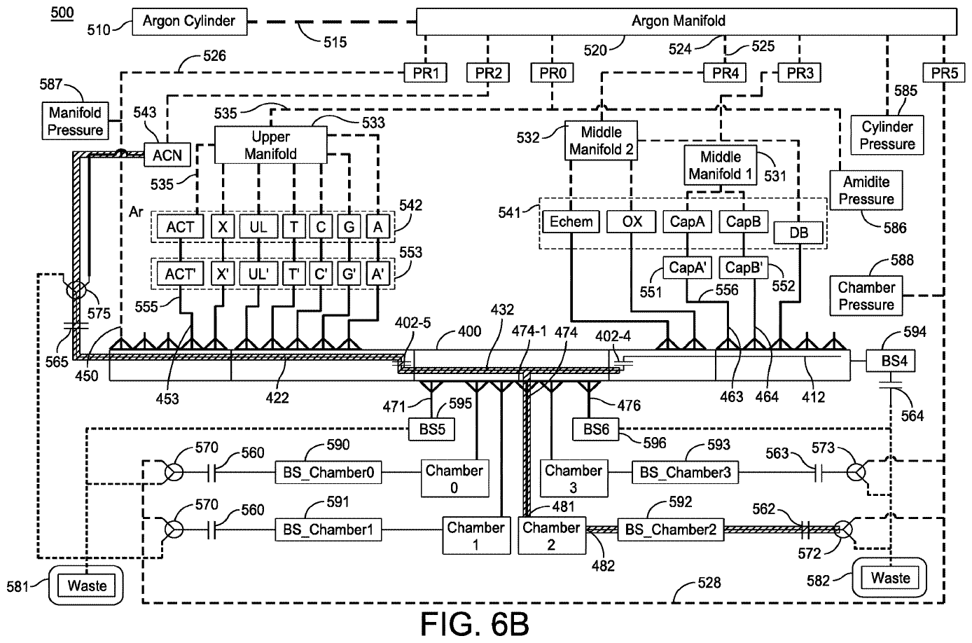

FIG. 6A illustrates an actuated fluidic pathway during a first operation of a washing liquid, e.g. ACN, in a reagent delivery system, e.g. the reagent delivery system 500, in accordance with some embodiments of the present disclosure. The bold lines in FIG. 6A represent a fluidic pathway going through all regions the ACN will pass by during the first operation. Before the first operation, all valves in the reagent delivery system 500 are closed. At the beginning of the first operation, all valves on the fluidic pathway in FIG. 6A are opened in an order from the downstream to the upstream of the fluidic pathway. That is, an outlet valve 476-1 controlling the outlet port 476 in the manifold 400 is first opened. Then, the shutoff valve 402-5 is opened to fluidically connect the dry-side common channel 422 and the outlet common channel 432. Then, the two-way valve 565 is opened to allow the ACN flowing into the dry-side common channel 422. Here, the three-way valve 575 is assumed to be switched to the ACN container 543 already before the first operation. In some embodiments, the three-way valve 575 may be switched to the ACN container 543 after the two-way valve 565 is opened to push the ACN into the dry-side common channel 422.

During the first operation, the ACN flows from the ACN container 543, through the three-way valve 575 and the two-way valve 565, into the dry-side common channel 422, then through the shutoff valve 402-5 and into the outlet common channel 432. As the shutoff valve 402-4 is closed, the ACN cannot flow into the wet-side common channel 412. The ACN will flow out of the manifold 400 through the outlet valve 476-1 and the outlet port 476, and be collected by the second waste container 582 as a waste. The bubble sensor 596 can monitor the status of the ACN flow, and indicate whether the outlet common channel 432 has been fully filled with the ACN. One purpose of the first operation is to use ACN to fill and/or wash the dry-side common channel 422 and the outlet common channel 432, e.g. in preparation of filling and/or washing a chamber later.

At the end of the first operation, all valves on the fluidic pathway in FIG. 6A are closed in an order from the upstream to the downstream of the fluidic pathway. That is, the two-way valve 565 is first closed to stop the ACN from flowing into the dry-side common channel 422. In some embodiment, the three-way valve 575 may be left as it is. In other embodiments, the three-way valve 575 may be switched from the ACN container 543 to the first waste container 581. Then, the shutoff valve 402-5 is closed to fluidically disconnect the dry-side common channel 422 and the outlet common channel 432. Then, the outlet valve 476-1 controlling the outlet port 476 is closed.

FIG. 6B illustrates an actuated fluidic pathway during a second operation of a washing liquid, e.g. ACN, in a reagent delivery system, e.g. the reagent delivery system 500, in accordance with some embodiments of the present disclosure. The bold lines in FIG. 6B represent a fluidic pathway going through all regions the ACN will pass by during the second operation. In some embodiments, the second operation is performed right after the first operation. Before the second operation, all valves in the reagent delivery system 500 are closed. At the beginning of the second operation, all valves on the fluidic pathway in FIG. 6B are opened in an order from the downstream to the upstream of the fluidic pathway. That is, the two-way valve 562 is first opened to allow a fluid flowing from the Chamber 2 to the second waste container 582. Here, the three-way valve 572 is assumed to be switched to the second waste container 582 already before the second operation. In some embodiments, the three-way valve 572 may be switched to the second waste container 582 before the two-way valve 562 is opened. Then, an outlet valve 474-1 controlling the outlet port 474 in the manifold 400 is opened. Then, the shutoff valve 402-5 is opened to fluidically connect the dry-side common channel 422 and the outlet common channel 432. Then, the two-way valve 565 is opened and the three-way valve 575 is switched to the ACN container 543 if not already, as described above for the first operation.

During the second operation, the ACN flows from the ACN container 543, through the three-way valve 575 and the two-way valve 565, into the dry-side common channel 422, then through the shutoff valve 402-5 and into the outlet common channel 432. The ACN will then flow out of the manifold 400 through the outlet valve 474-1 and the outlet port 474, and flow into Chamber 2. As the ACN has already filled up the outlet common channel 432 during the first operation, Chamber 2 can directly receive ACN at the beginning of the second operation without receiving impurities or leftovers from the outlet common channel 432. The bubble sensor 592 can monitor the status of the ACN flow into Chamber 2, and indicate whether the Chamber 2 has been fully filled with the ACN. The ACN flowing out of the Chamber 2 (after Chamber 2 is filled up) flows through the two-way valve 562 and the three-way valve 572, and is collected by the second waste container 582 as a waste. One purpose of the second operation is to use ACN to fill and/or wash the Chamber 2.

At the end of the second operation, all valves on the fluidic pathway in FIG. 6B are closed in an order from the upstream to the downstream of the fluidic pathway. That is, the two-way valve 565 is first closed to stop the ACN from flowing into the dry-side common channel 422. In some embodiment, the three-way valve 575 may be left as it is. In other embodiments, the three-way valve 575 may be switched from the ACN container 543 to the first waste container 581. Then, the shutoff valve 402-5 is closed to fluidically disconnect the dry-side common channel 422 and the outlet common channel 432. Then, the outlet valve 474-1 controlling the outlet port 474 is closed. The two-way valve 562 will be closed afterwards.

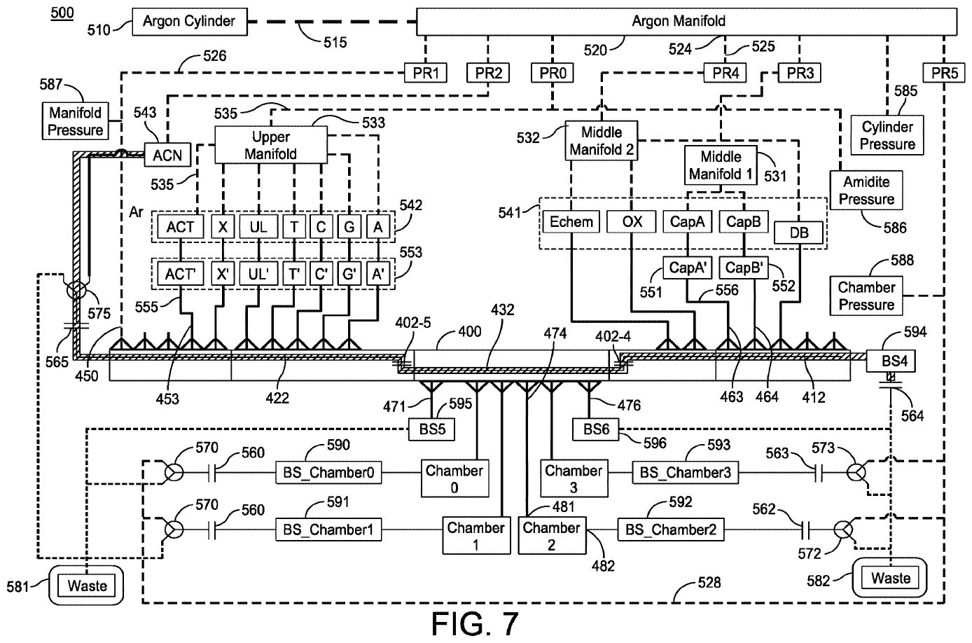

FIG. 7 illustrates an actuated fluidic pathway during a flush operation of a washing liquid, e.g. ACN (acetonitrile), in a reagent delivery system, e.g. the reagent delivery system 500, in accordance with some embodiments of the present disclosure. The bold lines in FIG. 7 represent a fluidic pathway going through all regions the ACN will pass by during the flush operation. Before the flush operation, all valves in the reagent delivery system 500 are closed. At the beginning of the flush operation, all valves on the fluidic pathway in FIG. 7 are opened in an order from the downstream to the upstream of the fluidic pathway. That is, the two-way valve 564 is first opened to allow a fluid in the wet-side common channel 412 to flow into the second waste container 582. Then, the shutoff valve 402-4 is opened to fluidically connect the wet-side common channel 412 and the outlet common channel 432. Then, the shutoff valve 402-5 is opened to fluidically connect the dry-side common channel 422 and the outlet common channel 432. Then, the two-way valve 565 is opened and the three-way valve 575 is switched to the ACN container 543 if not already, as described above for the first operation.

During the flush operation, the ACN flows from the ACN container 543, through the three-way valve 575 and the two-way valve 565, into the dry-side common channel 422, then through the shutoff valve 402-5 and into the outlet common channel 432, then through the shutoff valve 402-4 and into the wet-side common channel 412. The bubble sensor 594 can monitor the status of the ACN flow, and indicate whether the wet-side common channel 412 has been fully filled with the ACN. Extra ACN flowing out of the wet-side common channel 412 is collected by the second waste container 582 as a waste. One purpose of the flush operation is to use ACN to wash the wet-side common channel 412, the dry-side common channel 422 and the outlet common channel 432, e.g. after fluidic manipulation and transport using the manifold 400.

At the end of the flush operation, all valves on the fluidic pathway in FIG. 7 are closed in an order from the upstream to the downstream of the fluidic pathway. That is, the two-way valve 565 is first closed to stop the ACN from flowing into the dry-side common channel 422. In some embodiment, the three-way valve 575 may be left as it is. In other embodiments, the three-way valve 575 may be switched from the ACN container 543 to the first waste container 581. Then, the shutoff valve 402-5 is closed to fluidically disconnect the dry-side common channel 422 and the outlet common channel 432. Then, the shutoff valve 402-4 is closed to fluidically disconnect the wet-side common channel 412 and the outlet common channel 432. Then, the two-way valve 564 is closed.

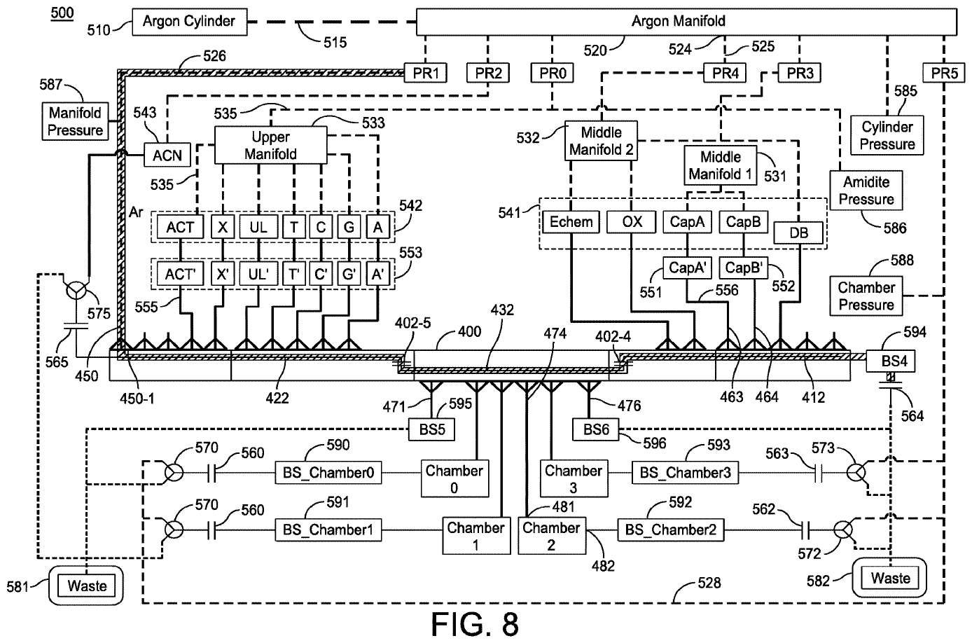

FIG. 8 illustrates an actuated fluidic pathway during a purge operation of an inert gas, e.g. argon, in a reagent delivery system, e.g. the reagent delivery system 500, in accordance with some embodiments of the present disclosure. The bold lines in FIG. 8 represent a fluidic pathway going through all regions the argon will pass by during the purge operation. In some embodiments, the purge operation of the inert gas may be performed right after the flush operation of the washing liquid.

Before the purge operation, all valves in the reagent delivery system 500 are closed. At the beginning of the purge operation, all valves on the fluidic pathway in FIG. 8 are opened in an order from the downstream to the upstream of the fluidic pathway. That is, the two-way valve 564 is first opened to allow a gas fluid in the wet-side common channel 412 to flow or blow into the second waste container 582. Then, the shutoff valve 402-4 is opened to fluidically connect the wet-side common channel 412 and the outlet common channel 432. Then, the shutoff valve 402-5 is opened to fluidically connect the dry-side common channel 422 and the outlet common channel 432. Then, an inlet valve 450-1 controlling the inlet port 450 in the manifold 400 is opened to allow the argon flowing into the dry-side common channel 422.

During the purge operation, the argon flows from the inert gas manifold 520, via the pressure regulator PR1, through the inlet valve 450-1 and the inlet port 450, into the dry-side common channel 422, then through the shutoff valve 402-5 and into the outlet common channel 432, then through the shutoff valve 402-4 and into the wet-side common channel 412. The bubble sensor 594 can monitor the status of the argon flow, and indicate whether the wet-side common channel 412 has been fully filled with the argon. Extra argon flowing out of the wet-side common channel 412 is collected by the second waste container 582 as a waste. One purpose of the purge operation is to use argon or another inert gas to purge the wet-side common channel 412, the dry-side common channel 422 and the outlet common channel 432, e.g. after fluidic manipulation at the manifold 400 and flushing the manifold 400.

At the end of the purge operation, all valves on the fluidic pathway in FIG. 8 are closed in an order from the upstream to the downstream of the fluidic pathway. That is, the inlet valve 450-1 controlling the inlet port 450 is first closed to stop the argon from flowing into the dry-side common channel 422. Then, the shutoff valve 402-5 is closed to fluidically disconnect the dry-side common channel 422 and the outlet common channel 432. Then, the shutoff valve 402-4 is closed to fluidically disconnect the wet-side common channel 412 and the outlet common channel 432. Then, the two-way valve 564 is closed.

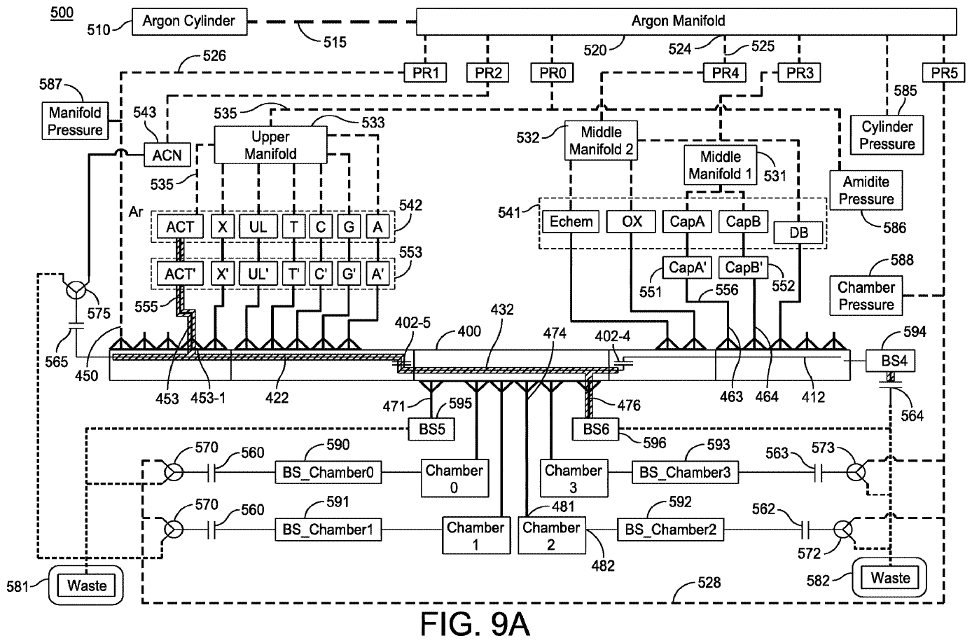

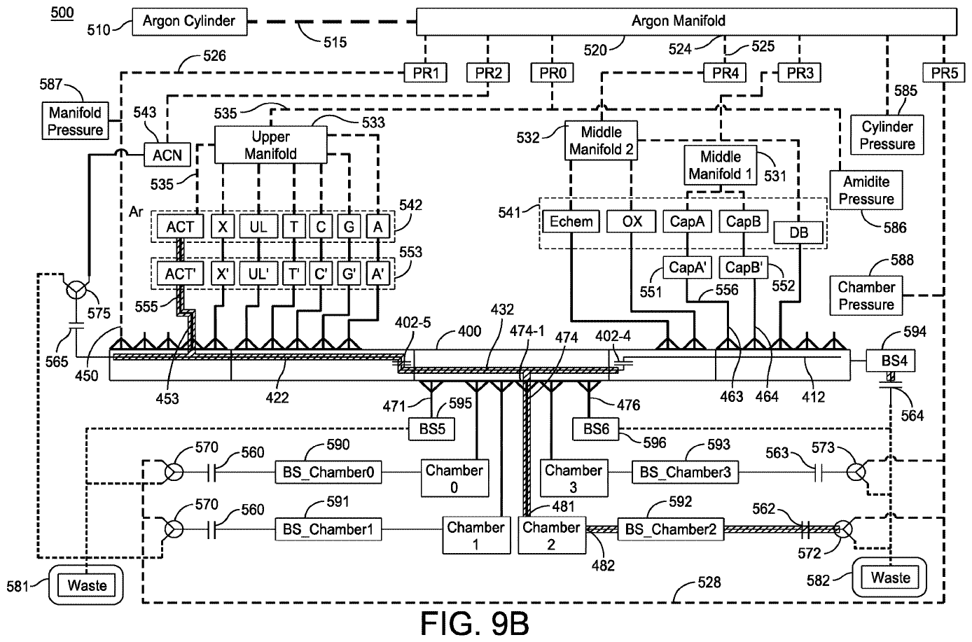

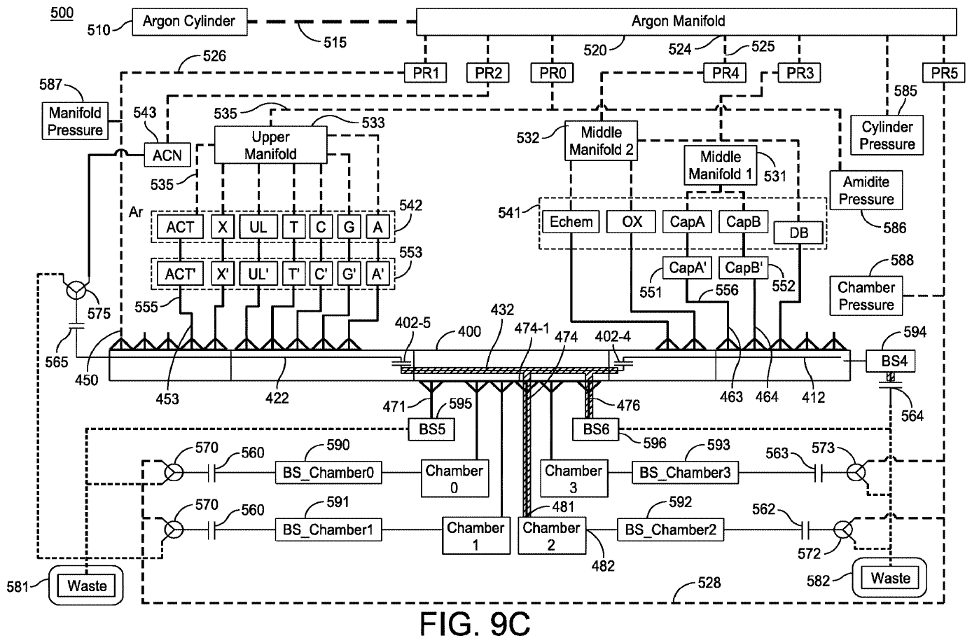

FIG. 9A illustrates an actuated fluidic pathway during a prime operation of a dry reagent, e.g. ACT, in a reagent delivery system, e.g. the reagent delivery system 500, in accordance with some embodiments of the present disclosure. ACT, which comprises an activator, is an exemplary dry reagent used to describe the operations applicable to every other dry reagent. The bold lines in FIG. 9A represent a fluidic pathway going through all regions the ACT will pass by during the prime operation. Before the prime operation, all valves in the reagent delivery system 500 are closed. At the beginning of the prime operation, all valves on the fluidic pathway in FIG. 9A are opened in an order from the downstream to the upstream of the fluidic pathway. That is, the outlet valve 476-1 controlling the outlet port 476 in the manifold 400 is first opened. Then, the shutoff valve 402-5 is opened to fluidically connect the dry-side common channel 422 and the outlet common channel 432. Then, an inlet valve 453-1 controlling the inlet port 453 is opened to allow the ACT flowing into the dry-side common channel 422. Here, the two-way valve 565 is closed, such that the ACT cannot flow out of the dry-side common channel 422 from the left end of the manifold 400.

During the prime operation, the ACT flows from the ACT container 542, through the inlet valve 453-1 and the inlet port 453, into the dry-side common channel 422, then through the shutoff valve 402-5 and into the outlet common channel 432. As the shutoff valve 402-4 is closed, the ACT cannot flow into the wet-side common channel 412. The ACT will flow out of the manifold 400 through the outlet valve 476-1 and the outlet port 476, and be collected by the second waste container 582 as a waste. The bubble sensor 596 can monitor the status of the ACT flow, and indicate whether the outlet common channel 432 has been fully filled with the ACT. One purpose of the prime operation is to use ACT to fill the dry-side common channel 422 and the outlet common channel 432, e.g. in preparation of filling a chamber later with the ACT.

At the end of the prime operation, all valves on the fluidic pathway in FIG. 9A are closed in an order from the upstream to the downstream of the fluidic pathway. That is, the inlet valve 453-1 controlling the inlet port 453 is first closed to stop the ACT from flowing into the dry-side common channel 422. Then, the shutoff valve 402-5 is closed to fluidically disconnect the dry-side common channel 422 and the outlet common channel 432. Then, the outlet valve 476-1 controlling the outlet port 476 is closed.

FIG. 9B illustrates an actuated fluidic pathway during a filling operation of a dry reagent, e.g. ACT, into a chamber in a reagent delivery system, e.g. the reagent delivery system 500, in accordance with some embodiments of the present disclosure. The bold lines in FIG. 9B represent a fluidic pathway going through all regions the ACT will pass by during the filling operation. In some embodiments, the filling operation in FIG. 9B is performed right after the prime operation in FIG. 9A. Before the filling operation, all valves in the reagent delivery system 500 are closed. At the beginning of the filling operation, all valves on the fluidic pathway in FIG. 9B are opened in an order from the downstream to the upstream of the fluidic pathway. That is, the two-way valve 562 is first opened to allow a fluid flowing from the Chamber 2 to the second waste container 582. Here, the three-way valve 572 is assumed to be switched to the second waste container 582 already before the filling operation. In some embodiments, the three-way valve 572 may be switched to the second waste container 582 before the two-way valve 562 is opened. Then, the outlet valve 474-1 controlling the outlet port 474 in the manifold 400 is opened. Then, the shutoff valve 402-5 is opened to fluidically connect the dry-side common channel 422 and the outlet common channel 432. Then, the inlet valve 453-1 controlling the inlet port 453 is opened to allow the ACT flowing into the dry-side common channel 422.

During the filling operation, the ACT flows from the ACT container 542, through the inlet valve 453-1 and the inlet port 453, into the dry-side common channel 422, then through the shutoff valve 402-5 and into the outlet common channel 432. The ACT will then flow out of the manifold 400 through the outlet valve 474-1 and the outlet port 474, and flow into Chamber 2, e.g. for deoxyribonucleic acid (DNA) synthesizer, chromatography or other chemical reactions or biotech operations. As the ACT has already filled up the outlet common channel 432 during the prime operation, Chamber 2 can directly receive ACT at the beginning of the filling operation without receiving impurities or leftovers from the outlet common channel 432. The bubble sensor 592 can monitor the status of the ACT flow in Chamber 2, and indicate whether the Chamber 2 has been fully filled with the ACT. The ACT flowing out of the Chamber 2 (after Chamber 2 is filled up) flows through the two-way valve 562 and the three-way valve 572, and is collected by the second waste container 582 as a waste. During the filling operation, the ACT flows into the Chamber 2 via port 481 and flows out of the Chamber 2 via port 482. One purpose of the filling operation is to transport ACT into Chamber 2 for some biotech and/or chemical operations.

At the end of the filling operation, all valves on the fluidic pathway in FIG. 9B are closed in an order from the upstream to the downstream of the fluidic pathway. That is, the inlet valve 453-1 controlling the inlet port 453 is first closed to stop the ACT from flowing into the dry-side common channel 422. Then, the shutoff valve 402-5 is closed to fluidically disconnect the dry-side common channel 422 and the outlet common channel 432. Then, the outlet valve 474-1 controlling the outlet port 474 is closed. The two-way valve 562 will be closed afterwards.

FIG. 9C illustrates an actuated fluidic pathway during a purge operation of a chamber filled with a dry reagent, e.g. ACT, in a reagent delivery system, e.g. the reagent delivery system 500, in accordance with some embodiments of the present disclosure. The bold lines in FIG. 9C represent a fluidic pathway going through all regions the ACT will pass by during the purge operation. In some embodiments, the purge operation in FIG. 9C is performed right after the filling operation in FIG. 9B. Before the purge operation, all valves in the reagent delivery system 500 are closed. At the beginning of the purge operation, all valves on the fluidic pathway in FIG. 9C are opened in an order from the downstream to the upstream of the fluidic pathway. That is, the outlet valve 476-1 controlling the outlet port 476 in the manifold 400 is first opened. Then, the outlet valve 474-1 controlling the outlet port 474 in the manifold 400 is opened. Then, the two-way valve 562 is opened, and the three-way valve 572 is switched to the pressure regulator PR5 to receive the pressured inert gas from the inert gas manifold 520.

During the purge operation, the inert gas, e.g. argon, flows from the inert gas manifold 520, via the pressure regulator PR5, through the three-way valve 572 and the two-way valve 562, into the Chamber 2. The inert gas flows into the Chamber 2 via port 482, and pushes the ACT (and any other liquid) left in the Chamber 2 out of the Chamber 2 via port 481. As such, the ACT (and any other liquid) flows out of the Chamber 2 via port 481, through the outlet valve 474-1 and the outlet port 474 into the outlet common channel 432. The ACT (and any other liquid) will flow out of the manifold 400 through the outlet valve 476-1 and the outlet port 476, and be collected by the second waste container 582 as a waste. The bubble sensor 596 can monitor the status of the ACT flow, and indicate whether the outlet common channel 432 has any ACT left. As such, the flowing direction of the ACT in the purge operation is opposite to the flowing direction of the ACT in the filling operation. One purpose of the purge operation is to use argon or another inert gas to purge the Chamber 2, e.g. after fluidic transportation to and operations in the Chamber 2.

In some embodiments, Chamber 2 (as well as every other chamber in the reagent delivery system 500) has a shape like a window, with a small thickness value, a regular length value, and a big height value. In some embodiments, the first chamber port 481 is located at the lower or bottom part of the window, while the second chamber port 482 is located at the higher or top part of the window. While a liquid reagent can easily enter Chamber 2 via the first chamber port 481 to push up the air or gas in Chamber 2 during the filling process, it is better to let the inert gas enter Chamber 2 via the second chamber port 482 to push down the liquid reagent in Chamber 2 during the purge process. As such, a flowing direction of the liquid reagent in Chamber 2 (as well as every other chamber in the reagent delivery system 500) during the filling process is different from its flowing direction during the purge process.

At the end of the purge operation, all valves on the fluidic pathway in FIG. 9C are closed in an order from the upstream to the downstream of the fluidic pathway. That is, the three-way valve 572 is first switched to the second waste container 582 to stop receiving the pressured inert gas from the inert gas manifold 520. Then, the two-way valve 562 is closed. Then, the outlet valve 474-1 controlling the outlet port 474 in the manifold 400 is closed. Then, the outlet valve 476-1 controlling the outlet port 476 in the manifold 400 is closed.

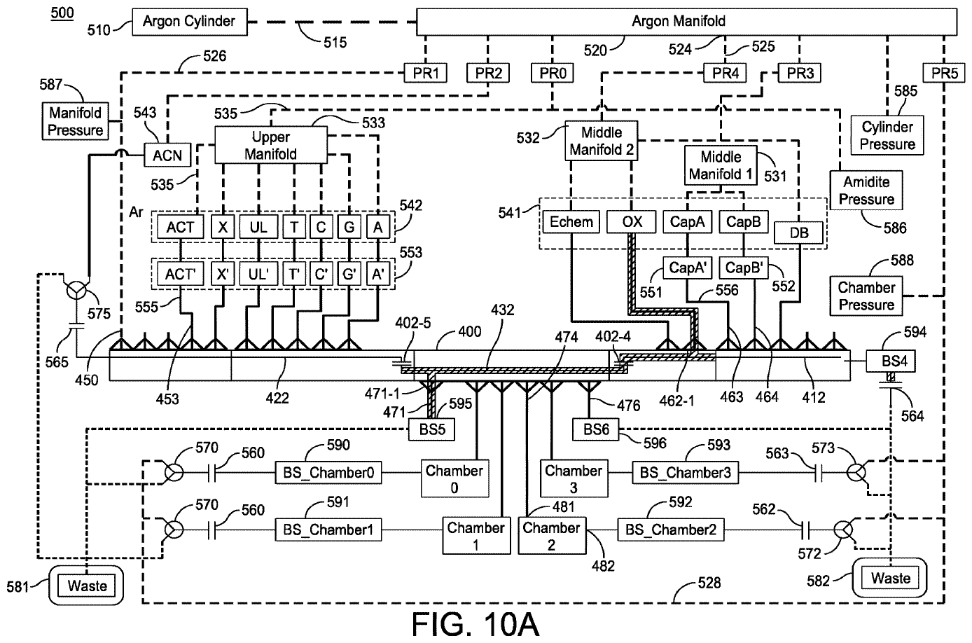

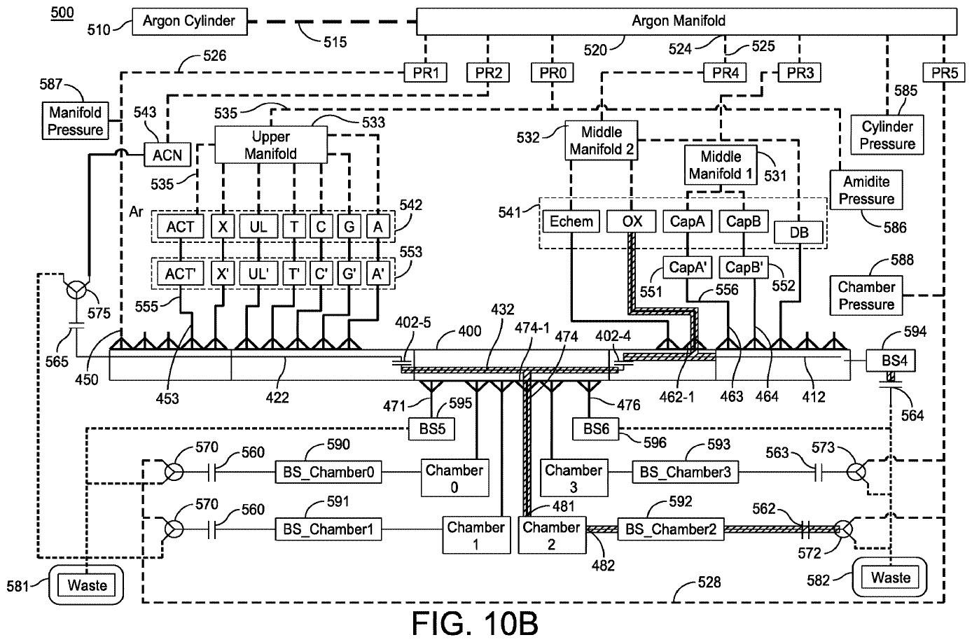

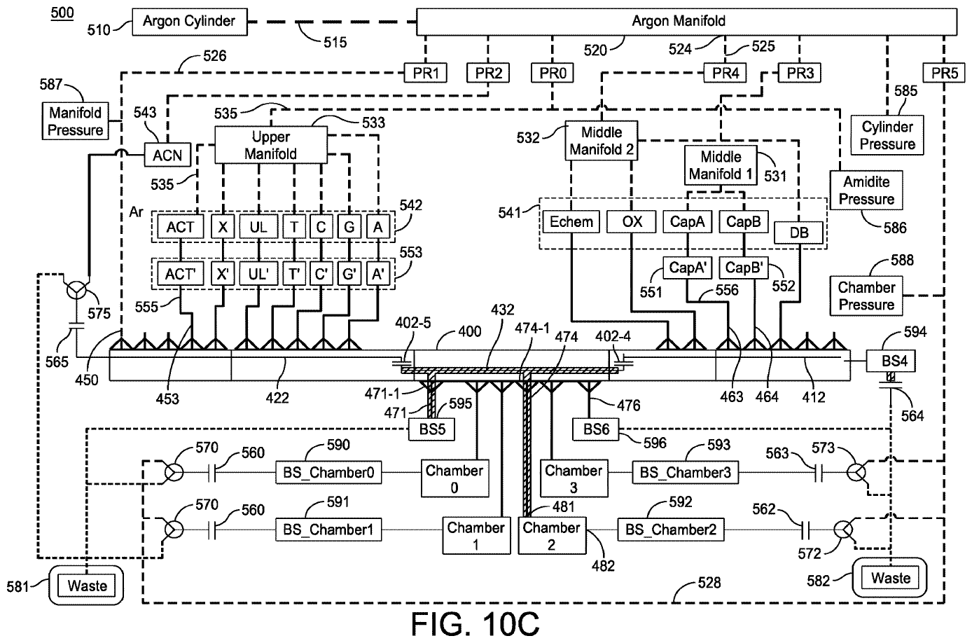

FIG. 10A illustrates an actuated fluidic pathway during a prime operation of a wet reagent, e.g. OX, in a reagent delivery system, e.g. the reagent delivery system 500, in accordance with some embodiments of the present disclosure. OX, which represents an oxidizer, is an exemplary wet reagent used to describe the operations applicable to every other wet reagent. The bold lines in FIG. 10A represent a fluidic pathway going through all regions the OX will pass by during the prime operation. Before the prime operation, all valves in the reagent delivery system 500 are closed. At the beginning of the prime operation, all valves on the fluidic pathway in FIG. 10A are opened in an order from the downstream to the upstream of the fluidic pathway. That is, the outlet valve 471-1 controlling the outlet port 471 in the manifold 400 is first opened. Then, the shutoff valve 402-4 is opened to fluidically connect the wet-side common channel 412 and the outlet common channel 432. Then, an inlet valve 462-1 controlling the inlet port 462 is opened to allow the OX flowing into the wet-side common channel 412. Here, the two-way valve 564 is closed, such that the OX cannot flow out of the wet-side common channel 412 from the right end of the manifold 400.

During the prime operation, the OX flows from the OX container 541, through the inlet valve 462-1 and the inlet port 462, into the dry-side common channel 422, then through the shutoff valve 402-4 and into the outlet common channel 432. As the shutoff valve 402-5 is closed, the OX cannot flow into the dry-side common channel 422. The OX will flow out of the manifold 400 through the outlet valve 471-1 and the outlet port 471, and be collected by the first waste container 581 as a waste. The bubble sensor 595 can monitor the status of the OX flow, and indicate whether the outlet common channel 432 has been fully filled with the OX. One purpose of the prime operation is to use OX to fill the wet-side common channel 412 and the outlet common channel 432, e.g. in preparation of filling a chamber later with the OX.

At the end of the prime operation, all valves on the fluidic pathway in FIG. 10A are closed in an order from the upstream to the downstream of the fluidic pathway. That is, the inlet valve 462-1 controlling the inlet port 462 is first closed to stop the OX from flowing into the wet-side common channel 412. Then, the shutoff valve 402-4 is closed to fluidically disconnect the wet-side common channel 412 and the outlet common channel 432. Then, the outlet valve 471-1 controlling the outlet port 471 is closed.

FIG. 10B illustrates an actuated fluidic pathway during a filling operation of a wet reagent, e.g. OX, into a chamber in a reagent delivery system, e.g. the reagent delivery system 500, in accordance with some embodiments of the present disclosure. The bold lines in FIG. 10B represent a fluidic pathway going through all regions the OX will pass by during the filling operation. In some embodiments, the filling operation in FIG. 10B is performed right after the prime operation in FIG. 10A. Before the filling operation, all valves in the reagent delivery system 500 are closed. At the beginning of the filling operation, all valves on the fluidic pathway in FIG. 10B are opened in an order from the downstream to the upstream of the fluidic pathway. That is, the two-way valve 562 is first opened to allow a fluid flowing from the Chamber 2 to the second waste container 582. Here, the three-way valve 572 is assumed to be switched to the second waste container 582 already before the filling operation. In some embodiments, the three-way valve 572 may be switched to the second waste container 582 before the two-way valve 562 is opened. Then, the outlet valve 474-1 controlling the outlet port 474 in the manifold 400 is opened. Then, the shutoff valve 402-4 is opened to fluidically connect the wet-side common channel 412 and the outlet common channel 432. Then, the inlet valve 462-1 controlling the inlet port 462 is opened to allow the OX flowing into the wet-side common channel 412.

During the filling operation, the OX flows from the OX container 541, through the inlet valve 462-1 and the inlet port 462, into the wet-side common channel 412, then through the shutoff valve 402-4 and into the outlet common channel 432. The OX will then flow out of the manifold 400 through the outlet valve 474-1 and the outlet port 474, and flow into Chamber 2, e.g. for DNA synthesizer, chromatography or other chemical reactions or biotech operations. As the OX has already filled up the outlet common channel 432 during the prime operation, Chamber 2 can directly receive OX at the beginning of the filling operation without receiving impurities or leftovers from the outlet common channel 432. The bubble sensor 592 can monitor the status of the OX flow in Chamber 2, and indicate whether the Chamber 2 has been fully filled with the OX. The OX flowing out of the Chamber 2 (after Chamber 2 is filled up) flows through the two-way valve 562 and the three-way valve 572, and is collected by the second waste container 582 as a waste. During the filling operation, the OX flows into the Chamber 2 via port 481 and flows out of the Chamber 2 via port 482. One purpose of the filling operation is to transport OX into Chamber 2 for some biotech and/or chemical operations.

At the end of the filling operation, all valves on the fluidic pathway in FIG. 10B are closed in an order from the upstream to the downstream of the fluidic pathway. That is, the inlet valve 462-1 controlling the inlet port 462 is first closed to stop the OX from flowing into the wet-side common channel 412. Then, the shutoff valve 402-4 is closed to fluidically disconnect the wet-side common channel 412 and the outlet common channel 432. Then, the outlet valve 474-1 controlling the outlet port 474 is closed. The two-way valve 562 will be closed afterwards.

FIG. 10C illustrates an actuated fluidic pathway during a purge operation of a chamber filled with a wet reagent, e.g. OX, in a reagent delivery system, e.g. the reagent delivery system 500, in accordance with some embodiments of the present disclosure. The bold lines in FIG. 10C represent a fluidic pathway going through all regions the OX will pass by during the purge operation. In some embodiments, the purge operation in FIG. 10C is performed right after the filling operation in FIG. 10B. Before the purge operation, all valves in the reagent delivery system 500 are closed. At the beginning of the purge operation, all valves on the fluidic pathway in FIG. 10C are opened in an order from the downstream to the upstream of the fluidic pathway. That is, the outlet valve 471-1 controlling the outlet port 471 in the manifold 400 is first opened. Then, the outlet valve 474-1 controlling the outlet port 474 in the manifold 400 is opened. Then, the two-way valve 562 is opened, and the three-way valve 572 is switched to the pressure regulator PR5 to receive the pressured inert gas from the inert gas manifold 520.

During the purge operation, the inert gas, e.g. argon, flows from the inert gas manifold 520, via the pressure regulator PR5, through the three-way valve 572 and the two-way valve 562, into the Chamber 2. The inert gas flows into the Chamber 2 via port 482, and pushes the OX (and any other liquid) left in the Chamber 2 out of the Chamber 2 via port 481. As such, the OX (and any other liquid) flows out of the Chamber 2 via port 481, through the outlet valve 474-1 and the outlet port 474 into the outlet common channel 432. The OX (and any other liquid) will flow out of the manifold 400 through the outlet valve 471-1 and the outlet port 471, and be collected by the first waste container 581 as a waste. The bubble sensor 595 can monitor the status of the OX flow, and indicate whether the outlet common channel 432 has any OX left. As such, the flowing direction of the OX in the purge operation is opposite to the flowing direction of the OX in the filling operation. One purpose of the purge operation is to use argon or another inert gas to purge the Chamber 2, e.g. after fluidic transportation to and operations in the Chamber 2.

At the end of the purge operation, all valves on the fluidic pathway in FIG. 10C are closed in an order from the upstream to the downstream of the fluidic pathway. That is, the three-way valve 572 is first switched to the second waste container 582 to stop receiving the pressured inert gas from the inert gas manifold 520. Then, the two-way valve 562 is closed. Then, the outlet valve 474-1 controlling the outlet port 474 in the manifold 400 is closed. Then, the outlet valve 471-1 controlling the outlet port 471 in the manifold 400 is closed.

Each inlet and outlet of the manifold 400 can be individually activated. In some embodiments, two reagents respectively in two reagent containers can be pushed together into the manifold 400 through two respective inlet ports. For example, when one outlet port 474 and two inlet ports 463, 464 are all open at the same time, Cap A and Cap B in the wet reagent containers CapA, CapB, respectively, can be delivered together into the Chamber 2 with equal amount, to mix with each other for some electro-chemical reactions.

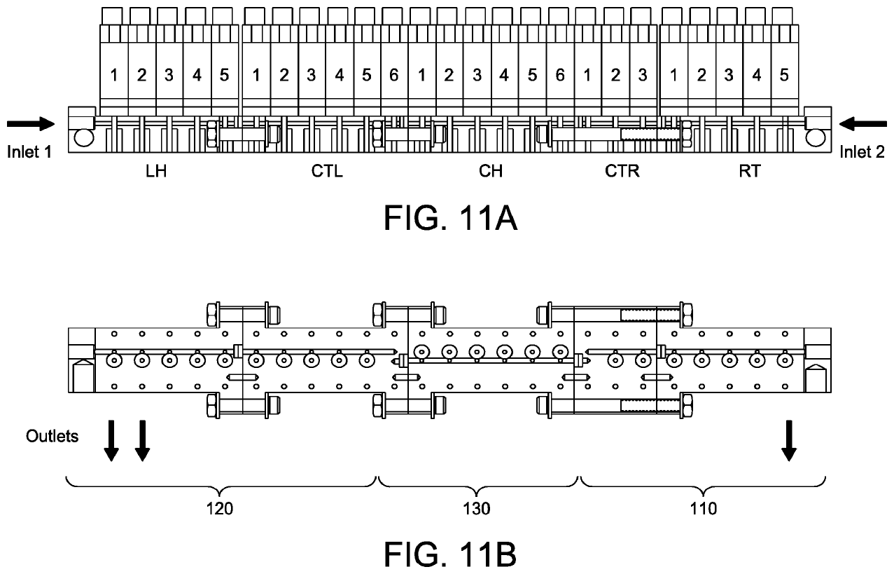

Referring to FIGS. 11A-11B, a fluidic manipulation device is tested for manifold function in accordance with some embodiments. The fluid manipulation device is the same as that described in FIGS. 1-3, except that the ports at the bottom are used for gas outlet during the testing. Similar to FIGS. 2B-2C, FIG. 11A is an exemplary cross-sectional side view of the fluidic manipulation device 100. Similar to FIG. 2A, FIG. 11B is an exemplary cross-sectional bottom view of the fluidic manipulation device 100. The blocks are labelled in “LH,” “CTL,” “CH,” “CTR,” and “RT,” based on the location and function. The codes “LH,” “CTL,” “CH,” “CTR,” and “RT” represent left hand, central left, chamber, center, and right, respectively.

The testing medium used is compressed air having a pressure in the range of 0.0827 MPa to 0.331 MPa (from 12 psi to 48 psi). The volume flow rate of the air used is in a range of from 4 L/minute (min.) to 40 L/min.

For an external leak test, all ports were pressurized and valves were actuated to test the valve mounting seal, O-ring at the manifold connection points, and the flatness of the 10-32 sealing surface. For a seat leak test, the near inlet was pressurized and valves were tested in the NC state (not actuated) to test the valve seat. During the external leak test, the valves are open. During the seat leak test, the valves are closed.

A duration for a leak test lasts 10 seconds. A leak test passing criterion is a pressure drop less than 1/1000 of the inlet pressure.

For a function flow test, a near inlet was pressurized and valves were tested individually to ensure valves are operating correctly and that there are no blockages in flow paths. The flow rate of the air used was tested. Such results indicated that the device can be used for reagents with good flows.

The following four groups of testing were performed.

1. The first group of testing performed for the valves in the LH Manifold (V1-V5) as shown in FIGS. 11A-11B.

1-1. External Leak Test: Inlet 1 (FIG. 11A) and the outlets were pressurized. The five valves (LH: V1-V5) were actuated (open). The pressurized gas was then shut off. After the leak test duration elapsed, the pressure drop was measured.

1-2. Seat Leak Test: Inlet 1 (FIG. 11A) was pressurized. The five valves (LH: V1-V5) were closed. The pressurized gas was then shut off. After the leak test duration elapsed, the pressure drop was measured.

1-3. Function Flow Test: Inlet 1 (FIG. 11A) was pressurized. The five valves (LH: V1-V5) were tested individually. An individual flow rate was recorded once a steady flow was reached.

2. The second group of testing performed for the valves in the CTL Manifold (CTL: V1-V5) and one valve in the CH Manifold as shown in FIGS. 11A-11B. Valve No. 6 in the CTL Manifold (CTL: V6) was actuated to test the flow through CH.

2-1. External Leak Test: Inlet 1 (FIG. 11A) and the outlets (FIG. 11B) were pressurized. The first five valves in the CTL Manifold and the first valve in the CH manifold (CTL: V1-V5; CH: V1) were actuated (open). The pressurized gas was then shut off. After the leak test duration elapsed, the pressure drop was measured.

2-2. Seat Leak Test: Inlet 1 (FIG. 11A) was pressurized. The first five valves in the CTL Manifold and the first valve in the CH manifold (CTL: V1-V5; CH: V1) were closed. The pressurized gas was then shut off. After the leak test duration elapsed, the pressure drop was measured.

2-3. Function Flow Test: Inlet 1 (FIG. 11A) was pressurized. The first five valves in the CTL Manifold and the first valve in the CH manifold (CTL: V1-V5; CH: V1) were tested individually. An individual flow rate was recorded once a steady flow was reached.

3. The third group of testing performed for the second to the sixth valves in the CH Manifold (CH: V2-V6) through CTR as shown in FIGS. 11A-11B. The first valve in the CTR Manifold (CTR: V1) was actuated to test the flow through CH.

3-1. External Leak Test: Inlet 2 (FIG. 11A) and the outlets were pressurized. The valves (CH: V2-V6) were actuated (open). The pressurized gas was then shut off. After the leak test duration elapsed, the pressure drop was measured.

3-2. Seat Leak Test: Inlet 2 (FIG. 11A) was pressurized. The valves (CH: V2-V6) were closed. The pressurized gas was then shut off. After the leak test duration elapsed, the pressure drop was measured.

3-2. Function Flow Test: Inlet 2 (FIG. 11A) was pressurized. The valves (CH: V2-V6) were tested individually. An individual flow rate was tested once a steady flow was reached.

4. The fourth group of testing performed for two valves in the CTR Manifold (CTR: V2-V3) and five valves in the RT Manifold (RT: V1-V5):

4-1. External Leak Test: Inlet 2 (FIG. 11A) and outlets were pressurized. The valves (CTR: V2-V3; RT: V1-V5) were actuated (open). The pressurized gas was then shut off. After the leak test duration elapsed, the pressure drop was measured.

4-2. Seat Leak Test: Inlet 2 was pressurized. The valves (CTR: V2-V3; RT: V1-V5) were closed. The pressurized gas was then shut off. After the leak test duration elapsed, the pressure drop was measured.

4-3. Function Flow Test: Inlet 2 was pressurized. The valves (CTR: V2-V3; RT: V1-V5) were tested individually. An individual flow rate was recorded once a steady flow was reached.

The testing results were shown in Table 1. As shown in Table 1, all the results including external leak and seat leak meet the passing criteria with a pressure drop less than 1/1000 of the inlet test pressure. The device including the valves and the ports has good seals and shows no or insignificant leakage. The function flow test results also indicate that the device including the valves can be operated correctly, with no blockages in flow paths. The device and the system provided in the present disclosure can be used for reagents with good flows.

TABLE 1

| | | | Test Pressure | Test Pressure |
|---|---|---|---|---|
| Test Group | Test | Function/ | (bar)/ | (bar)/ |
| No. 1 | Pressure | Flow | External Leak | Seat Leak |
| LH Manifold | (Bar) | (L/min) | (mbar) | (mbar) |
| LH V1 | 3.27 | 5.82 | 3.29/.85 | 3.29/.77 |
| LH V2 | 3.26 | 5.71 | | |
| LH V3 | 3.25 | 5.60 | | |
| LH V4 | 3.25 | 5.67 | | |
| LH V5 | 3.24 | 5.54 | | |
| Test Group | | | Test Pressure | Test Pressure |
| No. 2 | Test | Function/ | (bar)/ | (bar)/ |
| CTL & CH | Pressure | Flow | External Leak | Seat Leak |
| Manifold | (Bar) | (L/min) | (mbar) | (mbar) |
| CTL V1 | 3.24 | 5.75 | 3.29/.77 | 3.29/.79 |
| CTL V2 | 3.26 | 5.61 | | |
| CTL V3 | 3.24 | 5.60 | | |
| CTL V4 | 3.24 | 5.59 | | |
| CTL V5 | 3.24 | 5.50 | | |
| CH V1 | 3.23 | 6.00 | | |
| Test Group | | | Test Pressure | Test Pressure |
| No. 3 | Test | Function/ | (bar)/ | (bar)/ |
| CH & CTR | Pressure | Flow | External Leak | Seat Leak |
| Manifold | (Bar) | (L/min) | (mbar) | (mbar) |
| CH V2 | 3.26 | 6.87 | 3.29/.74 | 3.28/.82 |
| CH V3 | 3.24 | 6.70 | | |
| CH V4 | 3.25 | 6.68 | | |
| CH V5 | 3.26 | 6.65 | | |
| CH V6 | 3.23 | 6.72 | | |

| Test Group | | | Test Pressure | Test Pressure |
|---|---|---|---|---|
| No. 4 | Test | Function/ | (bar)/ | (bar)/ |
| CTR & RT | Pressure | Flow | External Leak | Seat Leak |
| Manifold | (Bar) | (L/min) | (mbar) | (mbar) |
| CTR V2 | 3.27 | 7.32 | 3.29/.73 | 3.28/.79 |
| CTR V3 | 3.24 | 7.29 | | |
| RT V1 | 3.24 | 7.37 | | |
| RT V2 | 3.23 | 7.29 | | |
| RT V3 | 3.23 | 7.31 | | |
| RT V4 | 3.26 | 7.41 | | |
| RT V5 | 3.24 | 7.36 | | |
| | Flow rate | 6.41 | | |
| | average | | | |
| | Flow rate | 0.74 | | |
| | std. dev. | | | |

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A fluidic device, comprising:
a plurality of first inlet ports;
a first common channel;
a plurality of first valves each associated with one of the plurality of first inlet ports, wherein each first valve is fluidically coupled between an associated first inlet port and the first common channel;
a plurality of second inlet ports;
a second common channel;
a plurality of second valves each associated with one of the plurality of second inlet ports, wherein each second valve is fluidically coupled between an associated second inlet port and the second common channel;
a plurality of outlet ports;
a third common channel;
a plurality of third valves each associated with one of the plurality of outlet ports, wherein each third valve is fluidically coupled between an associated outlet port and the third common channel;
a first shutoff valve fluidically coupled between the first common channel and the third common channel; and
a second shutoff valve fluidically coupled between the second common channel and the third common channel.

2. The fluidic device of claim 1, wherein:
the plurality of first inlet ports, the first common channel, the plurality of first valves and the first shutoff valve are integrated in a first input section of the fluidic device;
the plurality of second inlet ports, the second common channel, the plurality of second valves and the second shutoff valve are integrated in a second input section of the fluidic device;
the plurality of outlet ports, the third common channel and the plurality of third valves are integrated in an output section of the fluidic device; and
the output section is physically coupled between the first input section and the second input section.

3. The fluidic device of claim 2, wherein:
the first input section and the second input section are segregated from each other.

4. The fluidic device of claim 1, wherein:
all valves of the plurality of first valves, the plurality of second valves, the plurality of third valves, the first shutoff valve, and the second shutoff valve are disposed in parallel and on a same first side of the fluidic device.

5. The fluidic device of claim 4, wherein:
all ports of the plurality of first inlet ports, the plurality of second inlet ports, and the plurality of outlet ports are disposed on a same second side of the fluidic device; and
the second side is opposite to the first side.

6. The fluidic device of claim 1, wherein:
each first inlet port is configured to receive a first liquid; and
each second inlet port is configured to receive a second liquid.

7. The fluidic device of claim 6, wherein:
the first liquid is selected from the first group consisting of an oxidizer, a first capping reagent (A), a second capping reagent (B), and an electro-chemical reaction medium; and
the second liquid is selected from the second group consisting of amidites, an activator, and an inert gas.

8. The fluidic device of claim 7, wherein:
a separation of the first group and the second group minimizes cross contamination between the first group and the second group towards the outlet ports.

9. The fluidic device of claim 6, wherein:
the plurality of first inlet ports includes a first quantity of first inlet ports; and
the plurality of second inlet ports includes a second quantity of second inlet ports.

10. The fluidic device of claim 9, wherein:
the first quantity is different from the second quantity.

11. The fluidic device of claim 10, wherein:
the first quantity is less than the second quantity.

12. The fluidic device of claim 1, further comprising:
a plurality of first inlet channels each corresponding to one of the plurality of first inlet ports, wherein each first inlet channel is disposed vertically normal to a longitudinal direction of the fluid device in the fluidic device and fluidically coupled between a corresponding first inlet port and an associated first valve;
a plurality of second inlet channels each corresponding to one of the plurality of second inlet ports, wherein each second inlet channel is disposed vertically in the fluidic device and fluidically coupled between a corresponding second inlet port and an associated second valve; and
a plurality of outlet channels each corresponding to one of the plurality of outlet ports, wherein each outlet channel is disposed vertically in the fluidic device and fluidically coupled between a corresponding outlet port and an associated third valve.

13. The fluidic device of claim 12, wherein:
the first common channel, the second common channel, and the third common channel are horizontally disposed in the fluidic device along the longitudinal direction of the fluidic device.

14. The fluidic device of claim 13, wherein:
all channels of the plurality of first inlet channels, the plurality of second inlet channels, the plurality of third inlet channels, the first common channel, the second common channel, and the third common channel have a same cross sectional area and a same inner diameter.

15. The fluidic device of claim 14, wherein:
all valves of the plurality of first valves, the plurality of second valves, the plurality of third valves, the first shutoff valve, and the second shutoff valve have a same structure and a same orifice diameter.

16. The fluidic device of claim 15, wherein:
liquid flowing in each channel of the plurality of first inlet channels, the plurality of second inlet channels, the plurality of third inlet channels, the first common channel, the second common channel, and the third common channel is sealed from atmosphere and driven by a pressurized inert gas.

17. The fluidic device of claim 15, wherein:
the same cross sectional area is between 0.1 and 10 square millimeters;
the fluidic device has an internal volume between 1 and 100 milliliters; and
the same inner diameter is substantially the same as the same orifice diameter.

18. The fluidic device of claim 12, wherein:
a first valve, when open, allows a first liquid to flow from an associated first inlet port, through a corresponding first inlet channel, through the first valve, to the first common channel;
the first shutoff valve, when open, allows the first liquid to flow from the first common channel, through the first shutoff valve, to the third common channel; and
a third valve, when open, allows the first liquid to flow from the third common channel, through the third valve, through a corresponding outlet channel, to an associated outlet port.

19. The fluidic device of claim 12, wherein:
a second valve, when open, allows a second liquid to flow from an associated second inlet port, through a corresponding second inlet channel, through the second valve, to the second common channel;
the second shutoff valve, when open, allows the second liquid to flow from the second common channel, through the second shutoff valve, to the third common channel; and
a third valve, when open, allows the second liquid to flow from the third common channel, through the third valve, through a corresponding outlet channel, to an associated outlet port.

20. A reagent delivery system, comprising:
a plurality of first reagent containers each containing a respective first liquid reagent that is selected from a first group;
a plurality of second reagent containers each containing a respective second liquid reagent that is selected from a second group;
a fluidic device of claim 1.

21-44. (canceled)
